(19) United States
(12) Patent Application Publication
(10) Pub. No.: US 2026/0178642 A1
(43) Pub. Date: Jun. 25, 2026

(54) ENHANCED AI-BASED AUDIO-VISUAL PROCESSING

(71) Applicant: NVIDIA Corporation, Santa Clara, CA (US)

(72) Inventors: Mansata KAMAL, Pune (IN); Vishesh Gupta, Pune (IN); Rohit Singh, Pune (IN)

(21) Appl. No.: 18/990,241

(22) Filed: Dec. 20, 2024

(51) Int. Cl. G06F 16/34; G06F 16/68; G06F 16/683; G06F 16/783; G10L 15/26

(52) U.S. Cl. CPC G06F 16/345; G06F 16/685; G06F 16/686; G06F 16/784; G10L 15/26

(57) ABSTRACT

Embodiments of the present disclosure relate to enhanced AI-based audio-visual processing. Various aspects integrate multimodal analysis functionality that seamlessly combines and/or selects from audio, video, and/or text data to provide a holistic understanding of multimedia content. Relative to existing technologies, such an approach enables more accurate and contextually aware interpretations by leveraging the full spectrum of available information in multimedia content. By integrating these disparate sources of data, various embodiments achieve a more nuanced analysis that captures the complexity and richness of real-world multimedia scenarios.

### BACKGROUND

Existing media processing technology solutions typically focus on analyzing individual components of media content—namely audio, video, or text—separately. For example, audio-only technologies (e.g., voice assistants) focus solely on analyzing audio content, typically using speech recognition, audio classification, or natural language processing (NLP) to understand spoken language, identify speakers, or classify sounds. In another example, video-only technologies (e.g., surveillance systems or video summarization) analyze video frames to detect objects, track movement, classify scenes, or identify actions.

The focus on individual components of these technologies limits their ability to provide a holistic understanding of multimedia content, which often relies on the interplay between audio, visual, and textual elements. For example, audio-only technologies do not consider the visual elements of a video, which can significantly impact the understanding of content. For instance, in a video with a scene of someone waving but not speaking, an audio-only analysis would miss the waving gesture entirely. In another example, video-only technologies cannot interpret audio elements like dialogue, background music, or sound effects that are crucial for full scene understanding. Without audio, understanding the scene's full context is limited.

### SUMMARY

Embodiments of the present disclosure relate to enhanced AI-based audio-visual processing. Various aspects integrate multimodal analysis functionality that seamlessly combines audio, video (and/or other visual data types), and/or text data to provide a holistic understanding of multimedia content. Relative to existing technologies, such an approach enables more accurate and contextually aware interpretations by leveraging the full spectrum of available information in multimedia content. By integrating these disparate sources of data, various embodiments achieve a more nuanced analysis that captures the complexity and richness of real-world multimedia scenarios.

In operation, various embodiments first receive an input multimedia file comprising audio data and video data. Some embodiments then decode the audio data into an audio stream and video data into a video stream. Subsequent to decoding the data, some embodiments then generate a natural language transcript from the audio stream, (e.g., via a speech-to-text transformer) where the natural language transcript is associated with corresponding timestamps. Based at least in part on analyzing one or more frames of the video stream, some embodiments generate visual metadata associated with the video stream. For instance, Convolutional Neural Networks (CNNs), object detection, and/or panoptic segmentation can be used to detect and recognize objects such as faces in each video frame, which is stored as visual metadata. In some embodiments, this metadata is time-stamped to align with the corresponding video frames and/or timestamps of the audio transcript, allowing for detailed scene-by-scene analysis and synchronized integration with multiple data streams.

Some embodiments then generate a natural language response based on combining or selecting from a representation (e.g., an embedding) of at least a portion of the natural language transcript and at least a portion of the visual metadata. For example, in some embodiments, the generation of the natural language response is based on retrieving, via a Retrieval Augmented Generation (RAG) model, information associated with at least one of the audio data and the video data in a data store in response to a user query and passing the information to a generative component of the RAG to generate the natural language response. In an illustrative example, a user queries “Who scored the goal and how did it happen?” in the context of a soccer match video. Upon extracting user intent in the query, the RAG model starts by retrieving relevant information from a data store that contains both audio embeddings and video embeddings. These embeddings may have been generated and stored during the initial processing of the multimedia content, where the audio was transcribed, and the video was analyzed for visual metadata. The generative component uses this integrated data to construct a detailed, natural language response that captures the audio and visual elements of the event. For example, the generated output response to the query may be, “Player X scored the goal in the 78th minute. He skillfully received the ball, dribbled past two defenders, and made a powerful shot into the top corner of the net.”

### BRIEF DESCRIPTION OF THE DRAWINGS

The present systems and methods for enhanced AI-based audio-visual processing are described in detail below with reference to the attached drawing figures, wherein:

FIG. 1 is a block diagram illustrating an example audio-video system, in accordance with some embodiments;

FIG. 2 is a schematic diagram of an example pipeline for processing audio-visual data, according to some embodiments;

FIG. 3 is a schematic diagram illustrating example inputs and outputs to a language model, according to some embodiments;

FIG. 4 is a screenshot of an example user interface page illustrating a generated response to a user query, according to some embodiments;

FIG. 5 is a screenshot of an example user interface page illustrating a generated response to a user query, according to some embodiments;

FIG. 6 is a screenshot of an example user interface page illustrating a generated response to a user query, according to some embodiments;

FIG. 7 is a flow diagram of an example process for generates a response to a user query based on combining at least a portion of a first embedding and at least a portion of a second embedding, according to some embodiments;

FIG. 8 is a flow diagram of an example process for generating a natural language response, according to some embodiments;

FIG. 9A is a block diagram of an example generative language model system suitable for use in implementing at least some embodiments of the present disclosure;

FIG. 9B is a block diagram of an example generative language model that includes a transformer encoder-decoder suitable for use in implementing at least some embodiments of the present disclosure;

FIG. 9C is a block diagram of an example generative language model that includes a decoder-only transformer architecture suitable for use in implementing at least some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

As described above, existing solutions typically focus on analyzing individual components of media content separately. These solutions have made significant strides in their respective domains, offering specialized tools for tasks such as speech recognition, object detection, and text analysis. However, the fragmentation of these solutions limits their ability to provide a holistic understanding of multimedia content, which often relies on the interplay between audio, visual, and textual elements.

Audio analysis solutions are primarily designed to interpret spoken language and sound within media content. These systems often utilize Automatic Speech Recognition (ASR) technologies to convert speech into text, enabling applications such as voice assistants, podcast transcription services, and call center analytics. For example, speech-to-text technologies provide transcriptions by analyzing the phonetic and linguistic features of audio input. However, these solutions do not account for visual elements, which can significantly influence the interpretation of spoken words. For instance, an ASR system may accurately transcribe a conversation, but without visual context, it may miss crucial non-verbal cues such as gestures or facial expressions, leading to a partial understanding of the content thereby negatively impacting accuracy.

Some video analysis technologies leverage computer vision techniques to interpret visual data in video streams. These systems for example are adept at classifying scenes using deep learning models like convolutional neural networks (CNNs). Tools such as YOLO (You Only Look Once) and SSD (Single Shot Multibox Detector) may be employed in applications ranging from surveillance and autonomous vehicles to content moderation and video summarization. While video-only solutions excel in extracting visual information, they lack the ability to understand the audio content that accompanies the video. This limitation is significant in contexts where audio provides essential context, such as in sports broadcasts where commentary explains the visual actions, or in surveillance footage where sound cues may indicate the presence of an anomaly.

Transcript analysis solutions focus on interpreting text, often generated from audio via speech-to-text models. These systems use Natural Language Processing (NLP) techniques to analyze text for sentiment, summarize content, or extract key entities. Transcript-only solutions may be valuable for tasks such as document analysis, customer feedback analysis, and chatbot interactions. However, they do not incorporate visual or auditory context, which can result in a loss of meaning, particularly in scenarios where visual and audio elements contribute significantly to the overall message. For example, a transcript of a movie scene may capture the dialogue but fail to convey the emotional tone set by visual and auditory elements like lighting, music, and facial expressions.

Some technical problems with these existing technologies lies in their modality-specific focus, which restricts their ability to provide a comprehensive, contextually rich understanding of multimedia content. Each solution operates independently within its domain—audio, video, or text—without integrating the insights that could be gleaned from the other modalities. This separation leads to a fragmented understanding of the content, particularly in scenarios that require a multimodal perspective to fully grasp the context. For instance, understanding the complete narrative of a movie scene often depends on synchronizing visual cues, audio effects, and spoken dialogue. Without the integration of these elements, the analysis remains incomplete or inaccurate, missing the nuances that arise from their interaction.

Various embodiments relate to enhanced audio-visual processing (e.g., using multimodal transformers and/or Retrieval Augmented Generation (RAG) models). Some embodiments integrate multimodal analysis functionality that seamlessly combines audio, video, and text data to provide a holistic understanding of multimedia content. Relative to existing technologies, such an approach enables more accurate and contextually aware interpretations by leveraging the full spectrum of available information in multimedia content. By integrating these disparate sources of data, various embodiments achieve a more nuanced analysis that captures the complexity and richness of real-world multimedia scenarios. This integrated approach offers comprehensive solutions that provide contextually enriched outputs, paving the way for more sophisticated applications in areas such as sports casting, content moderation, and/or automated video summarization, among other applications.

In operation, various embodiments first receive an input multimedia file comprising audio data and video data. For example, a movie file in formats such as MP4, MOV, AVI, or MKV is received. Various embodiments then decode the audio data into an audio stream and video data into a video stream. For example, with respect to video decoding, the video data embedded within an MP4 file is first encoded using a video codec (e.g., H.264 or H.265). A media decoder then identifies the video codec and applies the corresponding decoding algorithm (e.g., an H.264 algorithm) to convert the encoded video data into a sequence of raw video frames. This process involves decompressing the video data, translating it from a compressed digital format to a format suitable for analysis (e.g., a sequence of RGB frames). The decoded video stream is now a sequence of video frames that represent the visual content of the movie. These frames can be processed individually for tasks like object detection, action recognition, or scene segmentation.

Subsequent to decoding the data, some embodiments then generate a natural language transcript from the audio stream, (e.g., via a speech-to-text transformer) where the natural language transcript is associated with corresponding timestamps. For instance, after decoding the audio data into a raw audio waveform, the audio stream is fed into a speech-to-text model (e.g., NVIDIA ASR). The speech-to-text model processes the audio to recognize and transcribe or diarize (via diarization) the spoken words into text. In some embodiments, as the model transcribes or diarizes the audio, it also captures the exact timing of each spoken word or phrase, producing a transcript where each segment of text is associated with corresponding timestamps and/or speakers. For example, if a commentator in a sports video says, “And he scores a fantastic goal!” at 00:10:05, the speech-to-text model outputs this text along with the timestamp, allowing the transcript to be aligned accurately with the visual frames of the video for synchronized analysis and playback, as described in more detail below.

Based at least in part on analyzing one or more frames of the video stream, some embodiments generate visual metadata associated with the video stream. For instance, as the video stream is processed, the system uses models and functionality such as convolutional neural networks (CNNs), object detection, and/or panoptic segmentation to detect and recognize objects and faces in each frame. For example, if the video shows a soccer match, the model might identify and track players and the ball. It detects “Player A” running with the ball and recognizes “Player B” based on facial features. Various embodiments then generates visual metadata for these frames, including details like the identities of “Player A” and “Player B,” their positions on the field, movement trajectories, and actions such as “dribbling” or “shooting.” In some embodiments, this metadata is time-stamped to align with the corresponding video frames and/or timestamps of the audio transcript, allowing for detailed scene-by-scene analysis and synchronized integration with other data streams like audio, as described in more detail below.

Some embodiments then generate a natural language response based on combining or selecting from a representation (e.g., an embedding) of at least a portion of the natural language transcript and at least a portion of the visual metadata. For example, in some embodiments, the generation of the natural language response is based on retrieving, via a Retrieval Augmented Generation (RAG) model, information associated with at least one of the audio data and the video data in a data store in response to a user query and passing the information to a generative component of the RAG to generate the natural language response. In an illustrative example, a user queries, “Who scored the goal and how did it happen?” in the context of a soccer match video. Upon extracting user intent in the query, the RAG model starts by retrieving relevant information from a data store that contains both audio and video embeddings. These embeddings may have been generated and stored during the initial processing of the multimedia content, where the audio was transcribed, and the video was analyzed for visual content. For the user query, the RAG model searches the data store for audio embeddings related to the term “scored the goal” and video embeddings that capture relevant actions like “shooting” and “celebration.” The RAG model retrieves the audio transcript where the commentator says, “Player X scores a fantastic goal in the 78th minute!” with a timestamp. Simultaneously, the model retrieves video data showing Player X receiving the ball, maneuvering around defenders, and kicking the ball into the net. The retrieved audio and video data are then passed to the generative component of the RAG model. This component integrates the information, considering both the textual description and the visual context provided by the video embeddings. The generative component uses this integrated data to construct a detailed, natural language response that captures both the audio and visual elements of the event. For example, the generated output response may be, “Player X scored the goal in the 78th minute. He skillfully received the ball, dribbled past two defenders, and made a powerful shot into the top corner of the net.”

In some embodiments, the generation of the natural language response is based on aligning a frame of the video data with a respective timestamp of the corresponding timestamps indicated in the natural language transcript. For example, a user query may be, “What happened when the referee blew the whistle in the second half?” Various embodiments first analyze the natural language transcript to find the portion of the audio where the referee blowing the whistle is mentioned (e.g., based on NLP and semantic analysis of the query and the transcript). The transcript might say, “At 55:30, the referee blows the whistle for a foul.” The timestamp “55:30” is extracted from the transcript, indicating when this event occurred in the audio and video streams. Using the timestamp “55:30,” some embodiments align this time with the corresponding video frames (and/or video timestamps) to find the exact moment in the video when the referee blows the whistle. For example, transformers can process video frames as sequences and generate natural language descriptions that account for the temporal and contextual relationships between objects and actions in the video. Such output natural language descriptions can then be matched against the audio transcripts (e.g. via semantic analysis or other NLP techniques) to align the audio transcript that is relevant to the query with the corresponding portion in the video. The video data is searched for the frame or sequence of frames that match this timestamp, showing the actions taking place at that specific moment. Some embodiments retrieve both the visual context (e.g., video frames showing the referee, the players' positions, and the ball) and the audio context (e.g., sound of the whistle and crowd reaction). This combined information provides a full picture of what occurred at the moment the referee blew the whistle. The generative component of the RAG model uses this aligned and integrated data to produce a comprehensive natural language response, such as “At 55:30 in the second half, the referee blew the whistle to call a foul. The video shows Player Y committing a foul on Player Z near the penalty box, and the crowd reacting loudly to the decision.”

By aligning the video frames with the respective timestamp indicated in the natural language transcript, various embodiments generate a detailed and contextually accurate natural language response. This approach ensures that the response incorporates both audio and visual elements, providing users with a comprehensive understanding of specific events in the multimedia content.

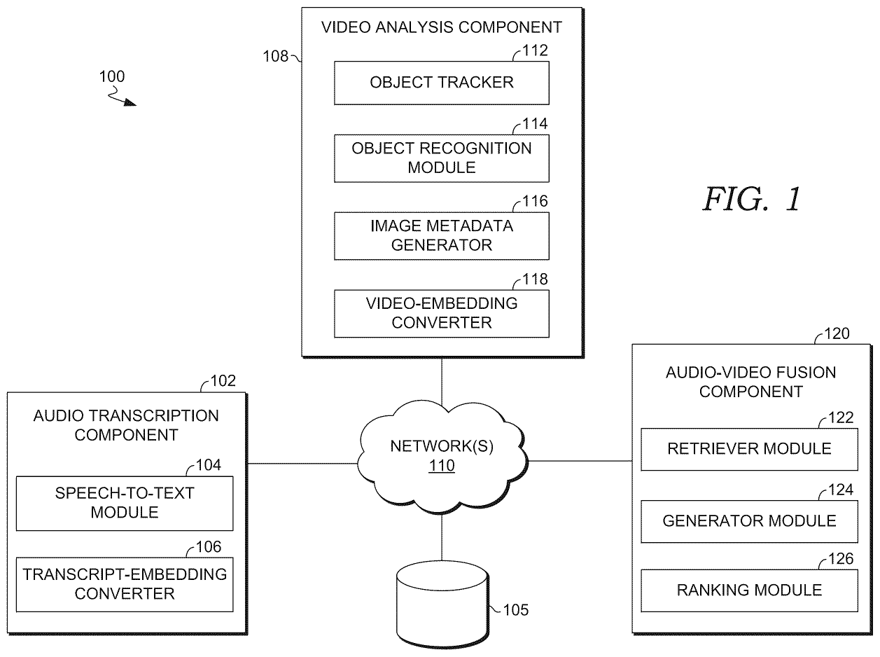

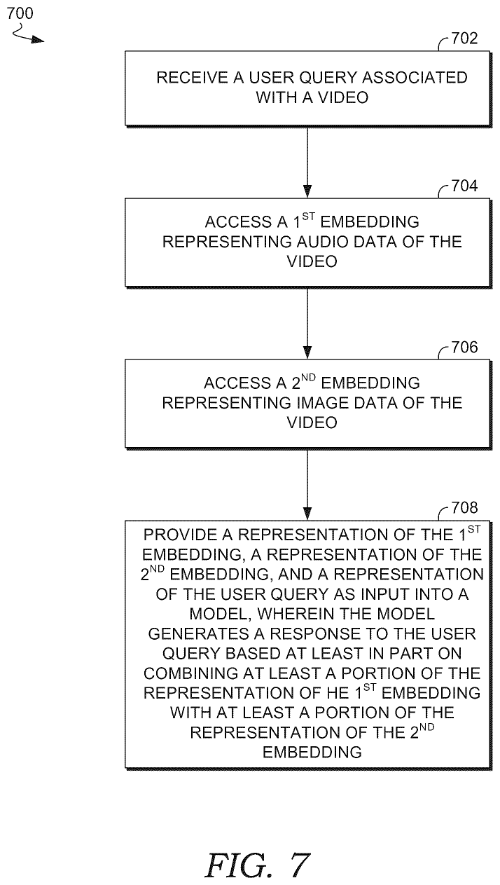

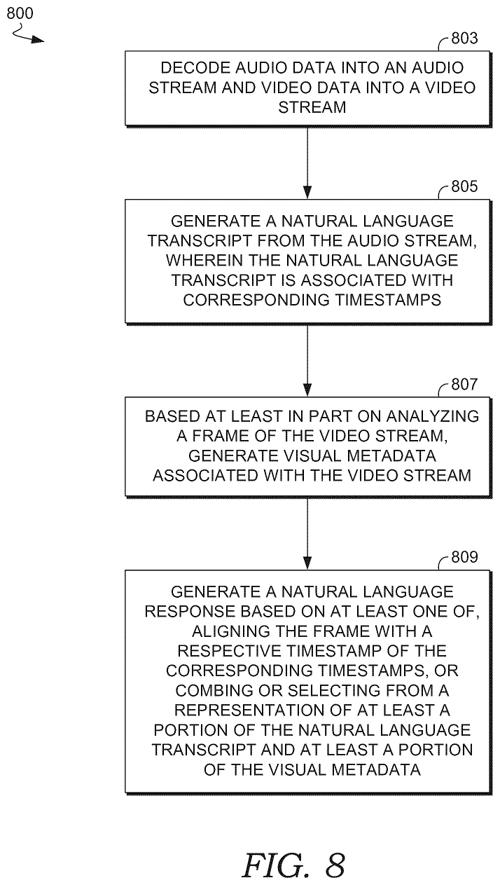

In some embodiments, the systems (e.g., the system 100 of FIG. 1) and methods (e.g., processes 700 of FIG. 7 and 800 of FIG. 8) described herein may be performed within a simulation environment (e.g., NVIDIA's DriveSIM) using simulated data (e.g., simulated sensor data of simulated sensors of a virtual or simulated machine). For example, simulated sensor data and/or map data may be used to identify regions of interest (e.g., detected persons) and sub-regions of interest (e.g., facial features of such detected persons) within the simulation environment, and may use this information to perform operations (e.g., generate visual metadata or natural language responses) associated with the virtual machine within the environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. The synthetic training data (in addition to or alternatively from real-world data) may then be processed to determine geometry and/or other information related to regions of interest, such as object velocity, activity category of the object (e.g., person running), for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

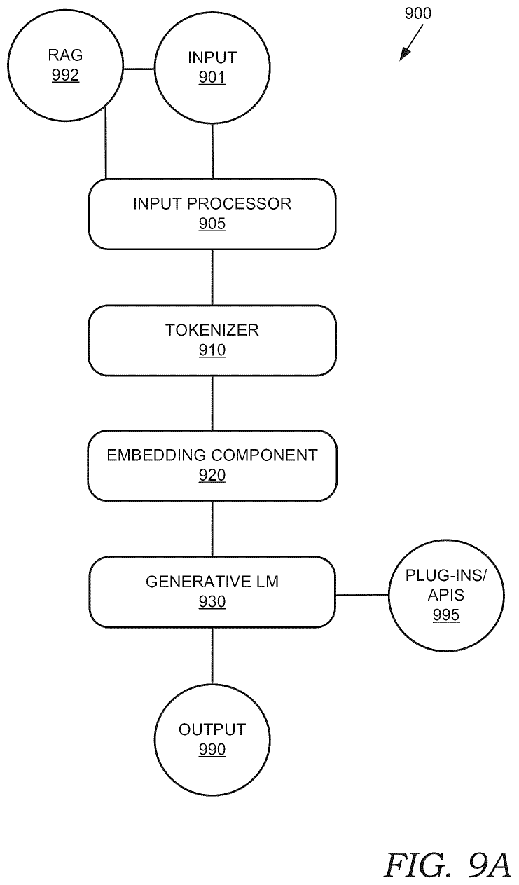

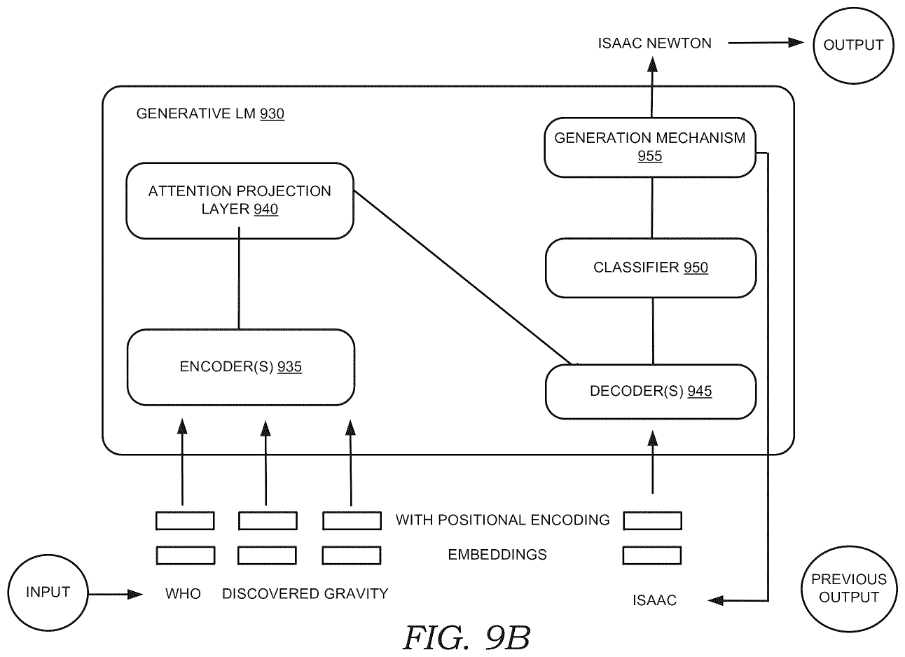

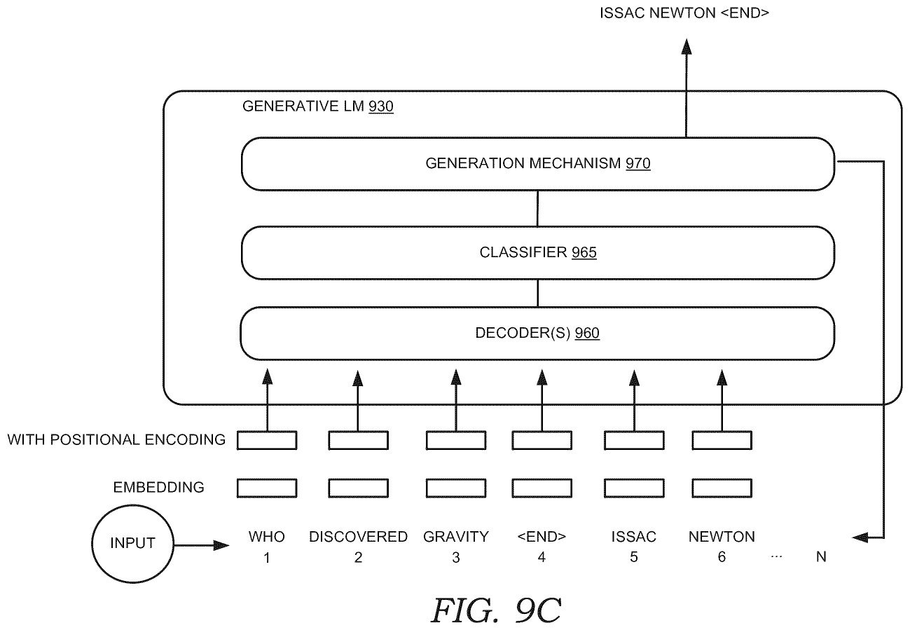

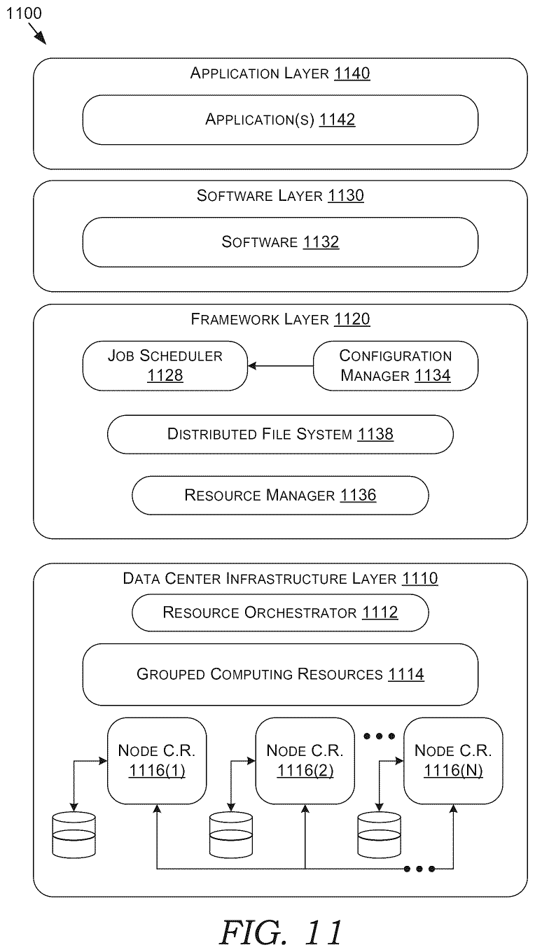

In some examples, any machine learning model described herein, such as a RAG model, the generative language model of FIG. 9A through 9C, any component of the audio transcription component 102 (e.g., the speech-to-text module 104), the video analytics component 108 (e.g., the object tracker 108), and/or the audio-video fusion component 120 of FIG. 1 may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model is small enough (e.g., has a small enough number of parameters), the model may be included within the container itself. In other examples—such as where the model is large—the model may be hosted/stored in the cloud (e.g., in a data center, such as in FIG. 11) and/or may be hosted on-premises and/or at the edge (e.g., on a local server or computing device, but outside of the container). In such embodiments, the model may be accessible via one or more APIs—e.g., REST APIs. As such, and in some embodiments, the machine learning models described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, vision language models (VLMs), large language models (LLMs), multi-modal language models (MMLMs), diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural rendering field (NeRF) models, models with encoder-only architectures, models with decoder-only architectures, models with encoder-decoder architectures, generative machine learning models, language models, large language models (LLMs), vision language models (VLMs), multi-modal language models (MMLMs), etc.), and/or other types of machine learning models.

### Example Audio-Video System

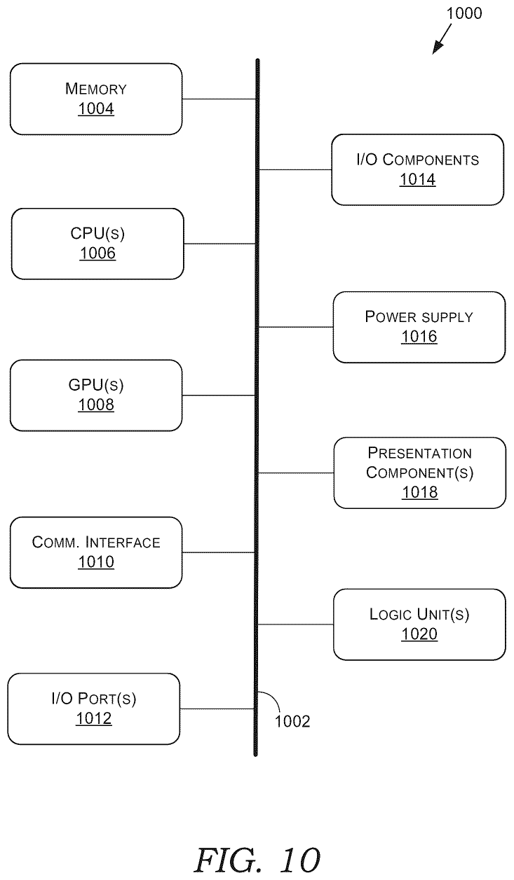

With reference to FIG. 1, FIG. 1 is a block diagram illustrating an example audio-video system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein, such as the system 100, may be executed using similar components, features, and/or functionalities to those of example generative models and generative model systems in FIGS. 9A, 9B, and 9C, example computing device 1000 of FIG. 10, and/or example data center 1100 of FIG. 11. In some embodiments, the system 100 includes fewer or more components as illustrated in FIG. 1.

In the embodiment illustrated in FIG. 1, the system 100 includes an audio transcription component 102, a video analytics component 108, an audio-video fusion component 120, and storage 105, each of which is communicatively coupled via one or more networks 110 (e.g., a Wide Area Network (WAN), a Local Area Network (LAN), a Personal Area Network (PAN), a cellular network, or the like). The system 100 is generally responsible for incorporating, synthesizing, and processing multiple modalities—audio, video, and text.

The audio transcription component 102 is generally responsible for transcribing the audio data (e.g., audio sound segments) from a multimedia file into text and generating audio embeddings that capture the semantic meaning of the spoken content. The audio transcription component 102 includes a speech-to-text module 104 and a transcript-embedding converter 106. The speech-to-text module 104 is generally responsible for converting sound segments into text or natural language characters. In some embodiments, the speech-to-text module 104 represents or includes a transformer-based speech-to-text module. For instance, this model can first perform feature extraction, where the audio input (e.g., sound segments) are first transformed into a series of feature vectors, using techniques like Mel-frequency cepstral coefficients (MFCCs) or spectrograms, which represent the frequency content of the audio over time. These feature vectors are then fed into the transformer model's encoder, which uses self-attention mechanisms to capture temporal dependencies and contextual relationships across the entire audio sequence, allowing the model to understand which parts of the audio are relevant to each other. The encoded representations are passed to the decoder, which generates text tokens (e.g., words or sub-words) one at a time. The decoder also employs attention mechanisms to focus on different parts of the encoded audio features while predicting the next token in the sequence, effectively translating the acoustic or sound information into natural language textual output.

In an illustrative example of the transformer-based speech-to-text model, there may be a 10-second audio clip of a news anchor saying, “Today, the weather will be sunny with a high of 75 degrees.” The model first converts the raw audio waveform of the 10-second clip into a series of feature vectors. For each new token it predicts, the decoder uses attention mechanisms to focus on relevant parts of the encoded audio features. This helps in determining the most likely next word based on the context of previously decoded words. As the decoding progresses, the model generates the text tokens: “Today,”, “the”, “weather”, “will”, “be”, “sunny”, “with”, “a”, “high”, “of”, “75”, “degrees.” These tokens are then assembled into a coherent sentence, producing the final transcript. The decoder's output is a sequence of text tokens that form the transcript, accurately representing the spoken words in the audio, aligned with the original timing of the audio segments: “Today, the weather will be sunny with a high of 75 degrees.” In some embodiments, as this transcription occurs, the model also records timestamps for each word or phrase, indicating when they were spoken in the audio stream. For example, the transcript might indicate that “Today” was spoken at 00:00:01 and “sunny” at 00:00:04.This process enables the transformer-based model to handle varying lengths of audio input and maintain context over long sequences, producing accurate and context-aware transcriptions.

It is understood that the speech-to-text module 104 alternatively or additionally includes other functionality, such as Hidden Markov Models (HMMs), Gaussian Mixture Models (GMMs), Recurrent Neural Networks (RNNs), Long Short-Term Memory Networks (LSTMs), Connectionist Temporal Classification (CTC), Deep Speech (based on RNNs and CTC), WaveNet, Convolutional Neural Networks (CNNs) combined with RNNs or LSTMs, Transformer-Transducer models, and/or End-to-End Attention-Based Models.

Some embodiments, fine-tune a model that represents the speech-to-text module 104. For example, there may be specific dataset that includes labeled pairs of audio data (e.g., sports broadcasting games, movies, etc. depending on the fine-tuning use case) and their corresponding text labels (representing the ground truth). Each audio file should have a precise transcription that matches the spoken content. For instance, a labeled pair could be an audio clip of a person saying “Hello, how are you?” with the transcription “Hello, how are you?” Fine-tuning often uses domain-specific data to make the model perform better in particular contexts (e.g., medical transcriptions, technical jargon, different accents).

In some embodiments, fine-tuning starts with a pre-trained model, such as a transformer-based speech-to-text model like Wav2Vec 2.0 or Whisper. These models have already learned general features of audio data and language. The pre-trained model serves as the base, and the fine-tuning process adjusts its parameters slightly to better adapt to the new dataset. The loss function (e.g., cross entropy loss) calculates the discrepancy between the predicted probability distribution (predicted transcription) of words and the actual distribution (the correct transcription). It penalizes more for incorrect predictions and rewards for correct ones. During each iteration, the model processes a batch of audio data and computes the predictions or transcripts. The loss is then calculated using the loss function, and backpropagation is used to compute the gradients of the loss with respect to each parameter in the model. The process of feeding data, calculating loss, computing gradients, and updating parameters is repeated for many iterations (epochs). Over time, the model's performance on the training data improves as the loss decreases. The goal is to find the optimal set of parameters where the loss function is minimized.

The transcript-embedding converter 106 is generally responsible for converting the natural language transcript generated by the speech-to-text module 104 into one or more embeddings, such as a text embedding. A text embedding is a numerical representation of text that captures the semantic meaning, context, and relationships between words, tokens, and/or phrases within a (e.g., high-dimensional) vector space. Text embeddings are created using machine learning models, such as neural networks, that learn to map words, sentences, or entire documents to vectors of real numbers. These embeddings are designed to place semantically similar texts close to each other in the vector space, enabling efficient and meaningful comparisons, searches, and analysis of textual data.

In an illustrative example, given a transcript (e.g., produced from transcription or diarization) like “The cat sits on the mat” with timestamps, a model like BERT would process the text to produce an embedding that represents the contextual relationships between the words (e.g., [0.12, −0.45, 0.78, 0.23, −0.34, 0.56, 0.89, −0.12, . . . ]). In some embodiments, the transcript-embedding converted 106 includes or represents BERT (Bidirectional Encoder Representations from Transformers), GPT (Generative Pre-trained Transformer), ROBERTa (A Robustly Optimized BERT Pretraining Approach), and/or Word2Vec.

In some embodiments, the transcript-embedding converter 106 is additionally responsible for storing the output text embedding to the data store 105 (e.g. vector DB). In some embodiments, the generated text embedding, along with its corresponding metadata (e.g., timestamps, source information, context tags), is packaged into a structured format, such as a JSON object or a database entry. The structured data containing the text embedding and metadata is inserted into the vector database. Vector DBs are optimized for handling high-dimensional vectors, allowing for efficient storage, retrieval, and similarity searches. The vector database indexes the embedding based on its vector values and associated metadata, storing it in a way that facilitates fast retrieval. This indexing allows the database to quickly find similar embeddings or specific entries based on queries or search criteria. By storing the text embedding in a vector database, various embodiments ensure that semantic information is easily accessible and searchable, enabling advanced analysis, context retrieval, and integration with other data streams (such as video or audio).

The video analytics component 108 is responsible for analyzing or processing video frames to detect and recognize objects, actions, and scenes, generating visual metadata and embeddings that capture the semantic content of the video. The video analytics component includes an object tracker 112, an object recognition module 114, an image metadata module 116, and a video-embedding converter 118.

The object tracker 112 is an algorithm or model that identifies and continuously follows a specific object across consecutive frames in a video. The object tracker 112 starts by detecting the object in the initial frame using an object detection model (e.g., a CNN), which provides the location and size of the object in the form of a bounding shape—a rectangular, square, polygonal, and/or other shaped outline that encloses the object. The tracker 112 extracts distinctive features from the object within the bounding shape, such as color, texture, shape, or learned deep features, which help differentiate the object from the background and other objects. The tracker 112 predicts the object's movement in the next frame based on its previous position, speed, and direction using motion models like Kalman filters or optical flow. In subsequent frames, the tracker 112 searches for the object by matching (e.g., via Kernelized Correlation Filters (KCF), Discriminative Correlation Filter (DCF), Mean Shift, Continuously Adaptive Mean Shift (CAMShift)) the extracted features within the predicted area or nearby regions, adjusting the bounding shape to fit the object's new location. For example, CAMshift algorithms use color histograms as features and iteratively move the search window to the region with the highest density of pixels matching the object's color distribution.

Once the object is located in the new frame, the tracker 112 updates the bounding shape position and refines its features based on the latest visual information, continuously repeating this process to track the object throughout the video. In essence, an object tracker 112 maintains the identity of an object by consistently updating its bounding shape across frames, leveraging both appearance features and motion dynamics to accurately follow its path.

The object recognition module 114 is generally responsible for performing object recognition, including facial recognition, and involves identifying and classifying objects (e.g., as cars or trees) or faces within an image or video frame. The first step is to detect the presence and location of objects or faces in an image or video frame (e.g., via the object tracker 112). This is done using object detection algorithms like Haar Cascades, Histogram of Oriented Gradients (HOG), or more advanced deep learning models like YOLO (You Only Look Once), SSD (Single Shot Multibox Detector), or Faster R-CNN. The output of this step is a set of bounding shapes that indicate where each object or face is located in the image.

Once a face or other object is detected, it may be aligned to ensure consistency in orientation and scale. This is particularly useful for facial recognition (which of course would only be employed after opt-in or consent), where facial features need to be normalized (e.g., aligned to a common reference frame) to improve recognition accuracy.

The detected regions (bounding shapes) are also preprocessed, which may include resizing, converting to grayscale, or normalizing pixel values to ensure the input is in a suitable format for the recognition model. Next, the object recognition module 114 performs feature extraction by extracting features from the detected object or face that are unique and descriptive. For facial recognition, features might include key points on the face (e.g., the eyes, nose, and mouth) or a deep feature vector representing the face's appearance. For example, Convolutional Neural Networks (CNNs) are used in some embodiments for deep feature extraction because they can learn complex patterns and hierarchies in visual data. For example, models like FaceNet or VGG-Face are trained to output a feature vector (embedding) that captures the unique characteristics of a face. The extracted features are then compared to a database of known objects or faces to determine identity or classify the object. In facial recognition, this involves comparing the feature vector of the detected face to a set of stored feature vectors in a database to find the closest match. Similarity measures like Euclidean distance or cosine similarity are used in so embodiments to compare feature vectors. If the similarity score between the detected face and a known face in the database is above a certain threshold, the module 114 recognizes the face as a match. In cases of general object recognition, after features are extracted, a classifier such as a Support Vector Machine (SVM) or a softmax layer (in the case of neural networks) is used to assign a label to the detected object. For example, the model outputs a probability distribution over different classes (e.g., identifying a detected object as a “car,” “person,” “bicycle,” etc.).

In some embodiments, the object recognition module 114 additionally or alternatively includes an action recognition model, which analyzes the sequence of frames to recognize activities or behaviors of objects or people (e.g., “person is running,” “car is stopping”). These models us the motion and context in the video to categorize different activities. Recurrent Neural Networks (RNNs) and/or Long Short Term Memory (LSTMs) are used in some embodiments. These models are particularly suited for sequential data and can capture long-range dependencies over time. In action recognition, RNNs or LSTMs process the extracted features from each frame sequentially, learning to predict the next feature based on the previous ones, thus modeling the temporal evolution of actions. Unlike 2D CNNs that operate on spatial dimensions, some embodiments use 3D CNNs, which apply convolutions across both spatial and temporal dimensions. This means a 3D CNN processes a block of consecutive frames as a single input, allowing it to learn spatiotemporal features that represent motion and appearance simultaneously.

Some embodiments then use Two-Stream Networks, which uses two separate networks: one stream processes spatial information (RGB frames) and the other processes temporal information (optical flow or motion). The outputs of both streams are then fused to recognize actions, benefiting from both appearance and motion information. After the spatiotemporal features are extracted and modeled, the resultant feature maps are fed into fully connected layers. These layers learn to classify the input video sequence into predefined action categories. In some embodiments, the final layer of the network is a softmax layer that outputs probabilities for each action class, indicating the likelihood that a given action is being performed in the video. Action recognition models may be trained on labeled video datasets where each video or video segment is annotated with the action being performed. During training, the model learns to map input video sequences to their corresponding action labels, minimizing the classification error. The model parameters are optimized using backpropagation and gradient descent, adjusting the weights to improve accuracy over time.

The image metadata generator 116 is generally responsible for generating and/or storing metadata associated with the object tracker 112 and/or the object recognition module 114. As objects are detected, tracked, recognized, and analyzed for activities, the image metadata generator 116 generates metadata for each relevant frame or sequence of frames. This metadata includes information such as object type, object ID, bounding shape coordinates, actions or activities, timestamps, and any other relevant details. Object type, for example includes labels identifying the type of object detected (e.g., “person,” “car,” “dog”). Bounding shape coordinates are another example of metadata, which includes the position and size of the bounding shape around the detected object (e.g., (x_min, y_min, x_max, y_max)). Object ID is a unique identifier for each tracked object to maintain consistency across frames (e.g., “Person_001,” “Car_003”). Activity type refers to the descriptions of actions or behaviors recognized by the system 11 (e.g., “person is running,” “car is stopping,” “dog is jumping”). Action duration is another type of metadata, which is the time span over which an activity occurs (e.g., “running from 00:01:23 to 00:01:27”). Movement trajectory refers to the information about the path or movement of tracked objects (e.g., “Person_001 moved from (x1, y1) to (x2, y2) over 5 seconds”). Recognition metadata includes the recognized identity of a detected face or object, if available (e.g., “John Doe,” “Red Sedan”). Metadata can also include a confidence score indicative of the model's confidence level in the recognition or classification (e.g., “Person_001 recognized as ‘John Doe’ with 95% confidence”). Temporal Metadata can include timestamps, which refer to the specific times when each piece of metadata was captured, aligned with the video frames (e.g., “Object detected at 00:00:15”), and/or specific times of the video itself. Frame Numbers reference the exact frames where events or objects are detected (e.g., “Event detected in frame 345”). Location metadata includes coordinates or regions within the frame where an object is detected or an action is taking place (e.g., “Running detected in region (x1, y1) to (x2, y2)”).

In some embodiments, the image metadata generator 116 generates metadata by generating natural language text that describes what is in one or more frames of a video. For instance, in some embodiments, CLIP (Contrastive Language-Image Pre-training) is used to generate such natural language text. CLIP is used to describe what is in a picture by associating images with text in a shared embedding space. It is trained on a diverse dataset of image-text pairs, learning to align visual and textual information in a way that allows it to understand both modalities simultaneously. CLIP uses an image encoder (e.g., a convolutional neural network (CNN)) or a vision transformer (ViT), to process the input image/frame. The encoder transforms the image into a high-dimensional vector (embedding) that represents the visual features and content of the image. Simultaneously, CLIP uses a text encoder, such as a transformer-based architecture, to convert text descriptions into a similar high-dimensional vector (embedding) space. The text encoder can handle various text inputs, such as captions, labels, or descriptive phrases, and transforms them into embeddings.

CLIP is trained using a contrastive learning approach, where the image and text embeddings are aligned in a shared embedding space. During training, CLIP learns to minimize the distance between embeddings of matching image-text pairs while maximizing the distance between non-matching pairs. This allows the model to understand the semantic relationships between images and text. To describe an image, CLIP computes the embedding of the input image using its image encoder. It then computes embeddings for a set of possible text descriptions using its text encoder. The model compares the image embedding to each text embedding by measuring cosine similarity, a metric that captures the similarity between two vectors based on their orientation. The text description with the highest cosine similarity to the image embedding is selected as the most relevant description of the image. This process allows CLIP to generate a natural language description that closely matches the content of the image.

The video-embedding converter 118 is responsible for converting video data (output by the object tracker 112, object recognition module 114, and/or image metadata generator 116) into embeddings and storing them in a separate vector store. This is done by processing video frames to generate vector representations that capture the semantic content of visual elements in the video. These embeddings represent various aspects of the video, such as objects, actions, and scenes, and are stored in a vector database (Vector Store) for efficient retrieval and analysis. For example, the video is divided into individual frames or sequences of frames (also known as clips). These frames are the basic units of visual information that the model analyzes. A CNN, for example, may extract spatial features that capture the visual appearance of objects, while a 3D CNN or two-stream network could extract both spatial and temporal features, capturing information about objects and their movements over time. The extracted features are then converted into high-dimensional vectors, known as embeddings. These embeddings encapsulate the semantic information of the frame or clip, representing details such as object types, activities, and contextual relationships in a compact form. A neural network layer, such as a fully connected (dense) layer, takes the feature map output by the CNN or 3D CNN and produces a fixed-size vector embedding. In some embodiments, this vector represents a summary of the features in a lower-dimensional space while preserving meaningful relationships.

In some embodiments, alongside embeddings, additional metadata from the image metadata generator 116, such as frame number, timestamp, bounding shape coordinates for detected objects, object identities, and activities, is generated and associated with each embedding. This metadata is useful for providing context and enabling precise queries in the vector store. In these embodiments, the embeddings, along with their associated metadata, are stored in a vector database. Vector stores are optimized for handling high-dimensional vector data, allowing for efficient similarity searches, retrieval operations, and queries based on embeddings. The vector store indexes the embeddings based on their values and associated metadata, facilitating fast retrieval based on content similarity or specific metadata queries. In some embodiments, where the image metadata generator 116 generates natural language text describing what is in a frame (e.g., via CLIP), the embeddings that are generated via the video-embedding converter 118 are text embeddings.

Similar to a model representing the speech-to-text module 104, in some embodiments, a model that represents any component of the video analytics component 108 is fine-tuned. For example, the dataset may include labeled video clips where each clip/frame is paired with annotations relevant to the task. For example, in action recognition, each video clip is labeled with the action it depicts (e.g., “running,” “jumping”). For instance, a labeled pair might include a video clip showing a person walking and the corresponding label “walking.” The fine-tuning process uses a loss function, like cross-entropy for classification or IoU for object detection, to measure the difference between the model's predictions and the actual labels. By iteratively applying gradient descent and backpropagation, the model's parameters are updated to minimize the loss, improving its performance on the target task, such as recognizing sports actions or detecting objects in videos.

The audio-video fusion component 120 is responsible for integrating text-based information from audio transcriptions (as generated by the audio transcription component 102) with visual data from video analysis (as generated by the video analysis component 108) to create a comprehensive, synchronized understanding of multimedia content. The audio-video fusion component 120 includes a retriever-generator module 122, an embedding consolidator 124, and a ranking module 126. In some embodiments, the audio-video fusion component 120 and/or more specifically the generator module 124 includes the architecture and functionality as described with respect to the generative language model and generative language model system described with respect to FIG. 9A, FIG. 9B, and FIG. 9C.

The retriever module 122 is generally responsible for retrieving (e.g., via Best Matching (BM) 25) one or more portions of the embeddings generated by the transcript-embedding converter 106, the video-embedding converter 118, and/or metadata generated by the image metadata generator 116. For example, BM25 could be used as a retrieval mechanism to search the audio transcripts, visual metadata, or other stored representations based on the user's query. It allows the system to rank and retrieve the most relevant pieces of information from the available data sources, such as audio transcripts or visual descriptions, and pass them to the generator 124 for response generation. For instance, the audio transcript (generated from the speech-to-text model) and video metadata (generated from the video analytics pipeline) (or representations of such, such as embeddings) are indexed in a searchable database. Each document (or segment of data) is indexed based on the words or terms it contains. For example, phrases like “defense,” “goal,” “coach,” and “players” from the transcript and metadata are indexed, with frequency and location stored. When the user submits a query (e.g., “What did the coach say during the halftime break?”), the system parses the query and breaks it into terms or keywords. For example, the system might extract the terms “coach,” “say,” and “halftime” from the query. The BM25 algorithm (e.g., the ranking module 126) is used to score each document (or segment of data, such as portions of the audio transcript or video metadata) based on how well it matches the query terms. BM25 considers how often the terms from the query appear in each document (TF), how important those terms are (IDF), especially if they are unique or rare. Adjustments for document length, so longer documents do not automatically get higher scores. BM25 assigns a score to each document (or segment), and the system selects the top-ranked documents as the most relevant to the query.

In another illustrative example, a retriever component of a Retrieval-Augmented Generation (RAG) model retrieves information by querying the vector database for relevant audio transcripts and video metadata embeddings based on a user query or system request/command. It searches the database using similarity measures or keywords to find the most contextually relevant embeddings (e.g., relative to the query), such as specific objects, actions, or spoken phrases, that match the query. For example, a user query may be, “What did the coach say during the halftime break?” The retriever module 122 first converts such query into a query embedding using a text encoder (e.g., a transformer model) that generates a vector representation capturing the semantic meaning of the query. The retriever module 122 uses this query embedding to perform a similarity search in the vector database, focusing on text embeddings that represent the audio transcripts. For instance, it calculates the cosine similarity between the query embedding and all stored text embeddings to find those that are semantically closest. Additionally or alternatively, the retriever module 122 performs a keyword search for terms like “coach,” “halftime,” and “say” within the metadata associated with the text embeddings, further narrowing down the results to those likely related to a halftime speech. The ranking module 126 then ranks the text embeddings based on their similarity scores to the query embedding and selects the top-N most relevant embeddings. For instance, it identifies text embeddings that correspond to transcript sections where the coach is speaking around the halftime timestamp.

In parallel, the retriever module 122 may also look for video embeddings around the halftime period that capture visual metadata of the coach, such as scenes of the coach addressing the team, to provide additional context. The retriever module 122 compiles the most relevant text and video embeddings, including their associated metadata (e.g., timestamps, locations, and actions). For example, it retrieves a text embedding where the coach says, “We need to focus more on defense,” along with a video embedding showing the coach gesturing emphatically.

The generator module 124 (e.g., an LLM, VLM, MMLM, etc.) is responsible for using the information retrieved by the retriever module 122 to generate a coherent and contextually accurate natural language response. The generation module 122 takes the retrieved embeddings (and/or raw natural language text), which represent both audio and video content, and synthesizes them into a meaningful output based on the user query or system request/command. These embeddings include text embeddings from the audio transcripts and visual embeddings from the video metadata, each capturing semantic information about the content. In some embodiments, the embeddings retrieved from the vector database are not directly fed into the generator module 124, such as where the generator module 124 represents an LLM. Instead, these embeddings are converted back into text or text-like data that the generator module 124 can process. This can involve reconstructing the original text from which the embeddings were generated or creating summaries or context information based on the embeddings. A lightweight neural network or decoder can be used to transform embeddings back into context-relevant text. This text represents the information encapsulated in the embeddings and can be something like: “The coach said to focus more on defense,” derived from audio embeddings, or “The coach was seen pointing towards the defensive line,” derived from video embeddings.

In some embodiments, the generator module 124 combines all the embeddings (or corresponding text representations) in a way that preserves the context provided by both the audio and video data. This ensures that the generation component has a holistic understanding of the multimedia content, taking into account the relationships between spoken words, visual actions, and objects. That is, the embeddings are fused or combined to ensure that the generated response reflects the content and context of both the audio and video data. In some embodiments, this fusion involves concatenating or summing the embeddings, aligning them temporally if necessary (e.g., via aligning timestamps of the audio and video data), and then processing them through a transformer model that uses attention mechanisms to weigh the importance of each modality's information. In the context of RAG, the transformer processes the concatenated or combined embeddings, allowing the model to learn which parts of the input embeddings are most relevant to the output generation. Self-attention is a mechanism that computes the relationships between all elements in the input sequence, allowing the model to focus on relevant parts of the data across modalities.

Mathematically, the combining or concatenation is expressed as follows: let E_{audio}∈R^{d×n} represent the audio embeddings, where d is the embedding dimension and n is the number of tokens or words in the transcript. Let E_{video}∈R^{d×m} represent the video embeddings, where m is the number of visual elements or frames considered. To combine these embeddings, some embodiments concatenate them along the temporal axis or sum them. For instance, for concatenation:

E_{combined}=[E_{audio},E_{video}]∈R^{d×(n+m)}.

For summation (assuming temporal alignment):

E_{combined}=E_{audio}+E_{video}∈R^{d×n}

The transformer applies a self-attention mechanism to E_{combined}. Self-attention calculates three vectors for each embedding: Query (Q), Key (K), and Value (V). The attention scores are computed by taking the dot product of the query and key vectors and scaling by the square root of the embedding dimension. This operation results in a matrix that represents the attention weights, indicating the importance of each embedding in generating the final output. The output of the self-attention layer is a weighted sum of the value vectors (V), where the weights are derived from the attention scores. This process ensures that the generated output by the generator module 124 incorporates information from both the audio and video embeddings, preserving the context provided by each modality.

The resulting embeddings are passed through additional layers of the transformer, including feed-forward neural networks and normalization layers, to produce the final output sequence by the generator module 124, which is a natural language response that integrates both audio and video data. In some embodiments, the generator module 124 uses a neural language model, such as GPT (Generative Pre-trained Transformer) or a similar transformer-based model, to generate text. This model processes the combined embeddings and uses attention mechanisms to focus on the most relevant parts of the retrieved information. The model generates a natural language response by predicting the most likely next word in a sequence, using the contextual cues provided by the embeddings. This process continues iteratively, producing a coherent response that accurately reflects the retrieved content. The generation module 126 thus produces a final natural language text (and/or image) output that answers the user's query or provides the requested information. The response is generated in a way that is grammatically correct and contextually relevant, ensuring that it aligns with the content of the multimedia data.

In an illustrative example, a user query is, “What did the coach do after the team scored the first goal?” The retriever module 122 identifies text embeddings from the transcript where the coach is speaking or reacting after the goal and video embeddings showing the coach's actions, such as celebrating or giving instructions. The generator module 124 receives these embeddings, which include: a text embedding from the transcript: “Great job, team! Let's keep up the pressure and play aggressively” and a video embedding showing the coach gesturing excitedly, clapping, and motioning for the players to push forward on the field. The generator module 124 uses a language model (e.g., GPT) to integrate these embeddings, understanding both the verbal encouragement and the physical actions of the coach. The model applies attention mechanisms to focus on relevant parts of the embeddings, ensuring that the generated response captures both the spoken words and visual context. The language model generates a natural language response that accurately reflects the retrieved content: “After the team scored the first goal, the coach was seen clapping enthusiastically and shouting, ‘Great job, team! Let's keep up the pressure and play aggressively,’ while motioning for the players to advance further up the field.” The output is the generated response by the generator module 124, “After the team scored the first goal, the coach was very animated, clapping his hands and encouraging the team to continue playing aggressively, urging them to push forward on the field.” By combining textual and visual information, the system 100 provides a comprehensive answer that reflects both what was said and what was seen, demonstrating the power of multimodal integration in enhancing the understanding and description of multimedia content.

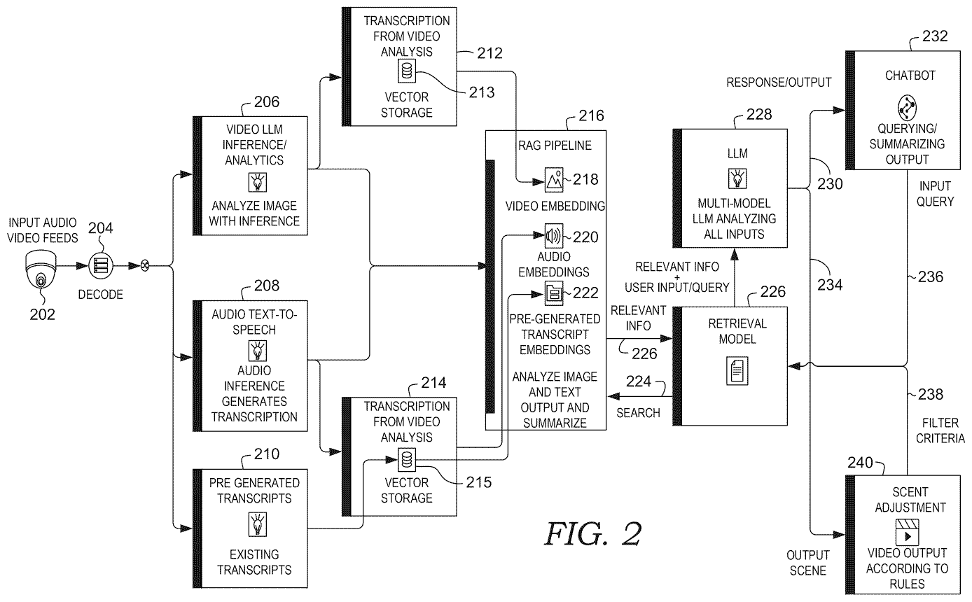

FIG. 2 is a schematic diagram of an example pipeline 200 for processing audio-visual data, according to some embodiments. In some embodiments, some or all of the components illustrated in the pipeline 200 of FIG. 2 represent or are included in the system 100 of FIG. 1, as described in more detail below. At a first time, an input audio-video feed(s) 202 is provided to a decoder 204. The audio-video feed(s) 202 represents the source of multimedia input, such as live video streams or pre-recorded video files that contain both audio and video data. For example, a live (or recorded) video stream of a football match broadcasted on television or online platforms may represent the input-audio-video feed 202, where this stream includes real-time video footage of the game and audio commentary from sports announcers, capturing the action as it unfolds.

The decode component 204 processes the input audio and video feeds to separate and prepare the audio and video data for analysis. This involves decoding the multimedia files into separate audio streams and video frames that can be further processed. For instance, an audio decoding component extracts the audio track from the multimedia file. It decodes the compressed audio data (such as AAC, MP3, or Opus codecs) into raw audio waveforms or PCM data, which can then be used for further processing like speech-to-text conversion or audio analysis. A video decoder simultaneously decodes the video track. This involves decompressing the video data (e.g., encoded in formats like H.264, H.265, or VP9) into raw video frames. Each frame represents a still image from the video stream that can be analyzed individually or in sequence for detecting objects, recognizing actions, or other visual analytics tasks. The decoded audio data is outputted as a continuous audio stream, ready for processing by the audio analytics pipeline (such as for transcription in 210 or audio feature extraction). The decoded video data is outputted as a sequence of video frames, which are then processed by the video analytics pipeline to extract visual features, perform object detection, and more.

In an illustrative example, a live sports broadcast stream needs to be analyzed to provide real-time commentary insights and player movement tracking. The input is a live video stream of a soccer match in H.264 format, encapsulated in an MP4 container, with an AAC-encoded audio track. The audio decode component extracts the AAC audio track from the MP4 container and decodes it into raw audio PCM data. This data is now ready for speech-to-text processing to transcribe the commentary. With respect to video decoding, the H.264 video track is extracted and decoded frame by frame. Each video frame is converted from the compressed video format to raw image data (e.g., YUV or RGB format), which represents the visual content of the soccer match. The raw audio stream is sent to the audio analytics pipeline, where a speech-to-text model converts the commentator's speech into text at 208. This text can be analyzed to identify mentions of key events or players. The raw video frames are sent to the video analytics pipeline, where a computer vision model detects and tracks players on the field, recognizes the ball, and identifies actions like “shooting” or “passing” at 206.

Audio speech-to-text component 208 (e.g., the speech-to-text module 104) performs speech-to-text conversion on the decoded audio stream decoded by the decode component 204. In some embodiments, the speech-to-text component 208 uses audio inference models to generate transcripts of the spoken content in the audio, converting it into natural language text format. Pre-generated transcripts 210 represents existing transcripts that may already be available for the input audio or video feeds. These pre-generated transcripts can be used in combination with (or alternative to) newly generated ones (i.e., those generated by the audio speech-to-text component 208) for analysis.

In transcription from audio analysis 214, the transcripts generated from the audio analysis (e.g., those transcripts generated by the speech-to-text component 208) are converted into embeddings that capture the semantic content of the text. These embeddings are then stored in a vector database (vector storage) 215 for later retrieval.

The video LLM inference/analytics 206 (e.g., the video analysis component 108 of FIG. 1) analyzes the decoded video frames using a VLM and/or other MMLM for inference. It performs tasks such as object detection, facial recognition, and action recognition, generating visual metadata and embeddings that capture the semantic content of the video. This component 206 uses a VLM, MMLM, and/or a multimodal model to analyze decoded video frames. This component leverages the capabilities of advanced models that can understand both visual and textual information, enabling them to perform tasks such as object detection, scene understanding, and action recognition by interpreting video content in a context-aware manner. For instance, the component 206 receives decoded video frames, which are the raw image data extracted from the video stream after the decoding process. These frames are in a sequence that captures the movement and actions occurring in the video. A neural network, such as a convolutional neural network (CNN) or a vision transformer, then processes each video frame to extract visual features. These features might include the presence of objects, the background scene, and other visual elements. If the model is designed to understand temporal sequences (like a 3D CNN or a model incorporating LSTMs for sequences), it processes multiple consecutive frames to capture the temporal dynamics—how objects and actions change over time. The extracted features from each frame or sequence of frames are converted into embeddings—vector representations that encode the semantic meaning of the visual content. These embeddings capture details such as what objects are in the frame, their positions, actions being performed, and any other relevant contextual information.

In some embodiments, VLMs/MMLMs are trained to integrate visual embeddings with textual/natural language data or to operate in a manner that aligns visual and language representations. In this case, the model may also take contextual textual data or use language-based understanding to enhance its inference capabilities. The VLM/MMLM processes the visual embeddings, potentially along with related text data, to infer high-level descriptions, recognize actions, or predict outcomes based on what is seen in the video. This is akin to understanding and describing the content in natural language, making the analysis richer and more context-aware. The model at 206 outputs descriptive or natural language-based metadata that includes recognized objects, detected actions, scene descriptions, and possibly captions or summaries that describe what is happening in the video frames. The model also produces high-dimensional embeddings that are stored in a vector database 213 for further retrieval and use in response generation or other analytics tasks.

In an illustrative example of VLM/MMLM inference/analytics 206, particular embodiments analyze a video of a person cooking in a kitchen. The decoded video frames show a sequence where a person is chopping vegetables, placing them in a pan, and stirring them on a stove. A vision transformer processes the video frames to extract features like the presence of a person, vegetables, a pan, and a stove. It also detects actions such as “chopping,” “placing,” and “stirring.” The extracted features are converted into embeddings that represent each object (e.g., “knife,” “vegetables,” “pan”) and actions (e.g., “chopping,” “stirring”) semantically. The model may use language understanding capabilities to infer that “the person is cooking” by integrating the visual actions of chopping and stirring with the context of a kitchen. The output generation includes descriptive natural language metadata: “Person chopping vegetables,” “Vegetables being placed in a pan,” “Person stirring vegetables on the stove.” The embeddings are stored for later use, such as generating a natural language description in response to a query. For example, the VLM/MMLM may generate a summary such as “A person is cooking by chopping vegetables and stirring them on the stove,” or metadata like detected objects (knife, vegetables, stove) and actions (chopping, stirring).

With respect to transcription from video analysis 212, similar to the audio analysis in 214, this component converts the video analysis results into embeddings that represent the visual content. These embeddings are also stored in a separate vector storage 213 for future retrieval.

The RAG (Retrieval-Augmented Generation) pipeline 216 (e.g., the audio-visual fusion component 120 of FIG. 1) integrates audio embeddings 220, video embeddings 218, and/or pre-generated text embeddings 222 (generated from the pre generated transcripts 210). It performs retrieval tasks by searching the vector storage in 215 and 213 for relevant information based on user queries or system needs/commands. It then analyzes the retrieved information and prepares it for summarization (e.g., LLM text summarization).

The retrieval model 226 (e.g., the retriever module 122 of FIG. 1) searches 224 the vector database(s) 213 and/or 215 using similarity measures (e.g., via semantic similarity or cosine distance) or keywords (e.g., via TF-IDF or fuzzy matching) to find the most relevant embeddings based on the user query or input criteria. It retrieves both audio and video embeddings that match the search parameters. In an illustrative example, the user query may be: “What instructions did the coach give to the players during the halftime break?” With respect to semantic similarity, the retrieval model 226 converts the user query into a query embedding using a language model (e.g., BERT). This embedding represents the semantic meaning of the query in a high-dimensional space. The retrieval model 206 searches 224 the vector database for text embeddings (from audio transcripts, pre-generated transcripts, and video metadata) that are semantically similar to the query embedding. It uses cosine similarity to measure the distance between the query embedding and each stored embedding, prioritizing those with higher similarity scores. For instance, an embedding in the vector database representing the text “The coach instructed the team to maintain defensive positions during halftime” might have a high cosine similarity score with the query embedding and so this text is then provided back to the retriever model 226 as the “relevant info.” 226.

The MMLM (Multi-Modal (e.g., Large) Language Model) (e.g., the generator module 124) receives the relevant information 226 retrieved by the RAG pipeline as well as the user query as input. It processes this information to generate a coherent and context-aware response or output 230 based on the combined audio and video data and the user query.

The chatbot component 232 uses the output 230 generated by the LLM 228 to provide answers or responses to user queries. It interacts with users, querying and summarizing the output based on their input. The chatbot component 232 acts as the user interface and interaction manager. It is responsible for managing the conversation flow, interpreting user queries, orchestrating the retrieval of information, passing the query to the LLM 228, and/or delivering the generated response back to the user device. It handles the overall dialogue management, tracks the state of the conversation, and ensures that the interaction is smooth and contextually appropriate. For example, a user is interacting with a system that provides summaries and insights from video footage of a sports game. The user asks, “Can you tell me what the coach said during the halftime break?” The chatbot component 232 interprets this query to understand that the user is looking for specific content related to the coach's speech at halftime. The chatbot component 232 performs query processing and retrieval by deciding which components of the system to activate. It sends a query/command to the retrieval model 226 to fetch relevant audio transcripts and video metadata embeddings from the vector database that pertain to the coach's halftime speech. The chatbot component 232 then forwards these embeddings to the LLM 228 for natural language processing. The chatbot component 232 receives the response from the LLM 228 and formats it appropriately. It might add additional context, such as timestamps or follow-up options for the user to ask further questions. In some embodiments, the chatbot component 232 provides the generated response to the user device and/or offer follow-up actions in the form of generated natural language responses, such as “Would you like to hear more about the strategies discussed?” The chatbot component 232 also provides continued interaction. For example, the user asks, “What were the players' reactions?” The chatbot component 232, having remembered (e.g., via cross attention) the previous query context, tailors the retrieval query to focus on player reactions during the same time frame and repeats the cycle of retrieving relevant data and generating a response.

Scene adjustment 240 takes the output from the retrieval model 226 and the output scene 234 and applies specific criteria or rules (e.g., from the user input query 236 or system commands) to adjust the video output. It processes the video according to the filter criteria 238 specified, potentially altering scenes or focusing on specific content. The scene adjustment component 240 is designed to modify the visual presentation of the video to better align with the user's needs (e.g., via the input query 236) or to highlight certain aspects of the video content. This can involve cropping, highlighting, zooming, altering playback speed, and/or even rearranging sequences of the video based on the analysis performed by the system.

The input to the scene adjustment component is the “output scene” 234, which refers to the segments of video that have been identified as relevant based on the user query or input criteria. The term “output scene” is understood as the portion of the video content that is selected for potential modification after being processed by the video analytics and retrieval components. Based on the metadata and embeddings generated by the video analytics pipeline 206, the scene adjustment component 240 applies specific rules or criteria to modify the video. These rules, for example, include focusing on certain objects, emphasizing specific actions, and/or altering the visual presentation to highlight relevant information. For example, this could include zooming in on a particular person or object, replaying a key action in slow motion, cropping to focus on a particular area of the frame, or adjusting the lighting or color to enhance visibility of important elements.

The output is an adjusted or modified version of the original video, tailored to better meet the user's query or the system's analysis goals. This adjusted scene is then presented to the user or used in subsequent analysis or reporting. In an illustrative example, a user queries the system for a specific event in a sports game, such as “Show me the moment when the player scored the winning goal.” The system uses its video analytics pipeline in 206 to identify the frames where the goal is scored. The retrieval model 226 pulls relevant video embeddings and metadata corresponding to the scoring event. The system then identifies the “output scene” as the sequence of frames that capture the player scoring the goal. This scene is now marked for potential adjustment to enhance the viewer's focus on the event. To emphasize the importance of the event, the scene adjustment component 240 applies a zoom effect on the player and the goal area. Additionally, the playback speed is reduced to slow motion during the goal-scoring moment to provide a detailed view of the action. Additionally or alternatively, the scene adjustment component 240 adds a graphical highlight (e.g., a spotlight or circle) around the player to draw attention to the action, enhancing the user's viewing experience. The final output is a modified video clip that zooms in on the player, plays the scoring action in slow motion, and highlights the player, providing a clear and focused view of the requested event, for example.

In some embodiments, a combination of machine learning models and video processing techniques are included in the scene adjustment 240. One model type that can contribute to scene adjustment through learned decision-making is the Reinforcement Learning (RL) model. Additionally, computer vision techniques like Optical Flow Analysis and Convolutional Neural Networks (CNNs) can also play a role in guiding adjustments. For example, reinforcement learning models can be used to perform scene adjustment by learning policies that maximize a reward based on the quality or relevance of the adjusted scenes. In this context, an RL agent would learn to make decisions on how to adjust video scenes to enhance the viewer's focus or emphasize important actions. The RL model receives input data, which includes video frames and associated metadata (e.g., detected actions, objects, and timestamps). Each state in the RL model corresponds to the current scene context, such as the frame content, detected objects, and ongoing actions. The model processes these states to understand the current video situation. The actions available to the RL agent include, for example, Zoom: adjusting the camera zoom level to focus on specific areas, pan: moving the focus horizontally or vertically across the frame, playback speed: Slowing down or speeding up the video to emphasize or de-emphasize certain actions, highlight: adding visual effects like spotlight or color enhancement around key objects or actions, and/or reframe: cropping the video to focus on a specific region or object. The RL model uses a reward function to evaluate the quality of each scene adjustment. Rewards are based on criteria like viewer engagement, clarity of highlighted actions, or accuracy in following user instructions (e.g., focusing on a specific event).

Over time, the RL model learns a policy that maps states (scene contexts) to actions (adjustments) to maximize the reward. For example, if zooming in on a player increases viewer engagement and understanding of an action, this action receives a positive reward and is more likely to be selected in similar future contexts. Based on the learned policy, the RL model executes scene adjustments by applying the selected actions to the video frames, modifying the video to enhance focus on relevant content or to meet specific user requests. For example, with respect to a sports highlight reel generation, the task is to automatically generate a highlight reel of key moments in a soccer game, focusing on goals, fouls, and exciting plays. The input is a full-length soccer match that is analyzed by the video analytics pipeline, identifying key moments like goals and fouls with associated metadata. States are defined by the current frame, detected actions (e.g., “goal scored”), and relevant objects (e.g., “player with the ball”). The RL model decides to apply the following actions: zoom in on the player as they approach the goal. Slow down the playback speed during the goal-scoring moment. Highlight the player with a spotlight effect immediately after the goal. Reframe the scene to exclude less relevant parts of the field, focusing on the players involved in the action. Rewards are given based on viewer engagement metrics, such as maintaining focus on the action and enhancing clarity and excitement of key moments. The adjusted video output is a highlight reel that dynamically zooms, slows down, and highlights key players and actions, enhancing the viewer's experience of the important moments in the match.

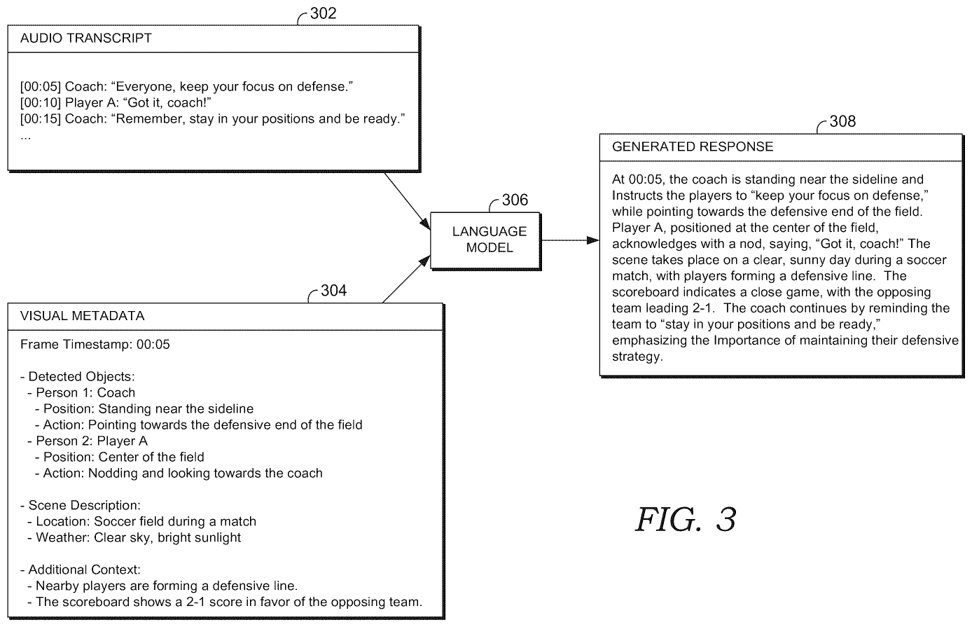

FIG. 3 is a schematic diagram illustrating example inputs and outputs to a language model, according to some embodiments. FIG. 3 includes an audio natural language transcript 302 (generated via transcription and/or diarization), visual metadata 304, a language model (e.g., an LLM, VLM, MMLM), and a generated response 308. In some embodiments, the audio transcript 302 represents what is output by the speech-to-text module 104 of FIG. 1. In some embodiments, the visual metadata 304 represents what is generated by the image metadata generator 116 of FIG. 1. In some embodiments, the language model 306 (e.g., LLM, VLM, MMLM, etc.) represents the generator module 124 of FIG. 1.

FIG. 3 illustrates that both the audio transcript 302 and the visual metadata 304 are provided as input to the language model 306. Responsively, the language model 308 generates the output response 308. In some embodiments, the generated response 308 represents LLM functionality, such as text summarization. The language model 306 uses attention mechanisms to weigh the importance of different pieces of information from both the transcript 302 and the visual metadata 304. For instance, it might place greater emphasis on key phrases like “focus on defense” while also highlighting visual actions that reinforce this instruction. By focusing on the most relevant aspects of both the audio and visual data, the language model 306 filters out less important details and prioritizes content that directly contributes to the narrative or scene description. Once the relevant details are identified, the language model 306 organizes them logically. It sequences the information in a way that naturally follows the flow of events, ensuring coherence. For example, it first describes the coach's verbal instructions, then the players' reactions, and finally the overall context of the scene (e.g., game score or environmental conditions). The model 306 integrates the selected details into a cohesive narrative, merging audio and visual information seamlessly. With the consolidated and organized information, the language model 306 generates natural language text that captures the essence of both the audio transcript and visual metadata. It constructs sentences that flow logically and convey the integrated information effectively.

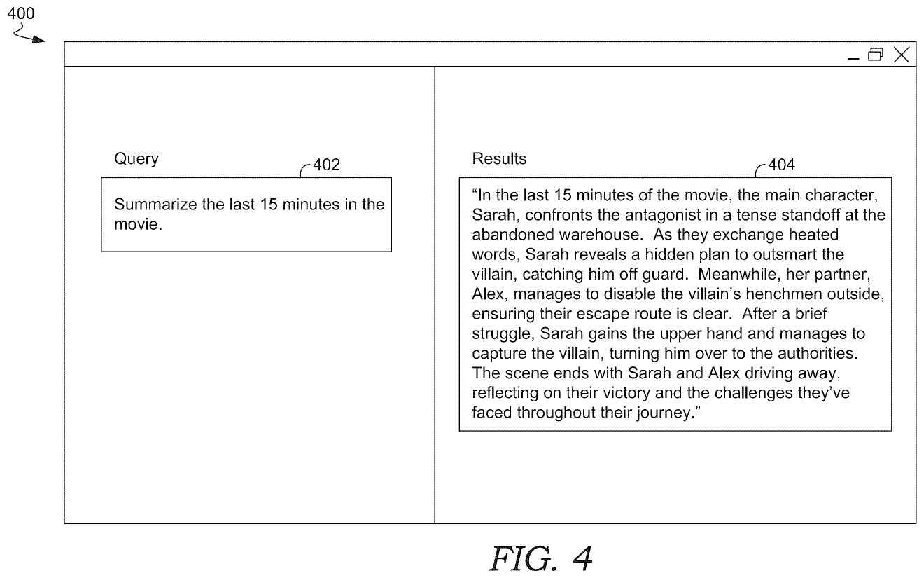

FIG. 4 is a screenshot of an example user interface page 400 illustrating a generated response 404 to a user query 402, according to some embodiments. At a first time, particular embodiments receive an indication that a user has issued the query 402 by inputting text into a field. Responsive to such functionality, the audio-video fusion component 120 performs its functionality to generate the results 404 (e.g., via the generative module 124). Prior to such functionality, various embodiments have uploaded a video (e.g., via a user selection of a button at the page 400). Responsive to such upload, the decoding component 204 of FIG. 2, the audio transcription component 102, and/or the video analytics component 108 of FIG. 1 performs their respective functions on the uploaded video.

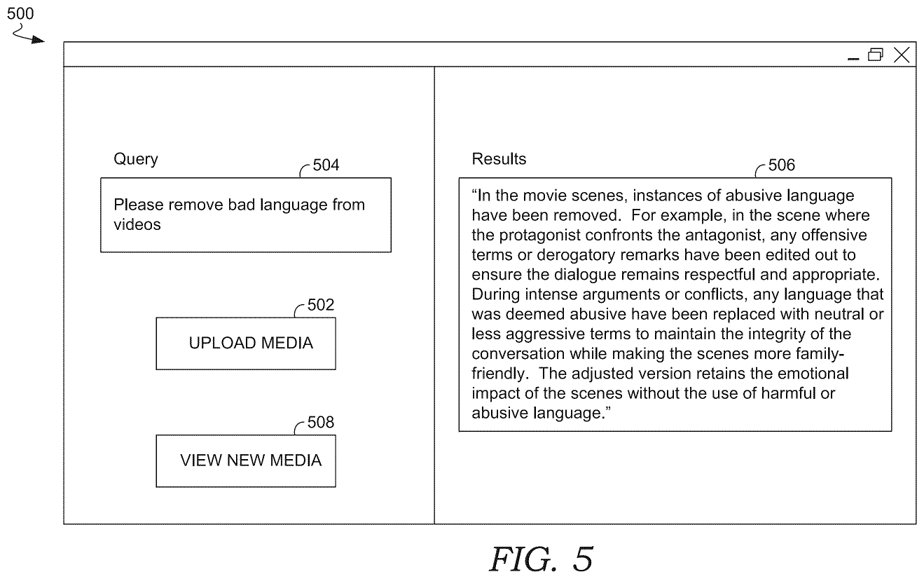

FIG. 5 is a screenshot of an example user interface page 500 illustrating a generated response 506 to a user query 504, according to some embodiments. At a first time, particular embodiments receive an indication that a user has selected the “upload media” button 502. After the video has been uploaded, the decoding component 204, the audio transcription component 102, and/or the video analytics component 108 performs their respective functionalities. In response to receiving an indication that the user has issued the query 504, the audio-video fusion component 120 performs its functionality and communicates with a video editing service so that a language model can generate the response output 506.

In an illustrative example, an LLM processes an audio natural language transcript to detect abusive language, offensive phrases, or any dialogue that matches predefined criteria for removal (such as curse words or derogatory remarks). The LLM analyzes context, understanding not just individual words but also the tone and implications of entire sentences. The video analytics component 108 also detects visual indicators of abusive behavior (e.g., violent actions, aggressive gestures) using trained classifiers or action recognition networks. For example, a model might identify someone making threatening gestures or engaging in physical violence. The results from the audio analysis and video analysis are synchronized based on timestamps (e.g., from both the audio transcript and the video data). This allows the system to align the detected abusive language with the corresponding visual content in the video. Both the LLM and the video analytics component 108 flag specific segments of the video that contain abusive language or behavior. These flagged segments are marked for potential removal or modification.

Based on the flagged content, the LLM generates editing instructions or guidelines. For example, it might recommend: removing or muting a specific segment where abusive language is detected, blurring or cutting out a scene where abusive behavior is identified, and/or replacing specific audio segments with neutral content or silence. An example output may be: “Remove 00:02:15 to 00:02:20 where abusive language is detected. Blur 00:02:22 to 00:02:25 to hide offensive gestures.” An automated video editing tool or software (e.g., FFMPEG, Adobe Premiere Pro scripts, or custom editing algorithms) takes the instructions generated by the LLM and applies them to the video file. This could include: trimming the video to remove flagged segments, muting audio or replacing it with non-offensive dialogue or background music, blurring or masking visual elements that display abusive behavior, and/or replacing Scenes. Responsively, the video editing tool instructs the LLM to generate the response 506 based on the actions it has taken, as illustrated in FIG. 5.

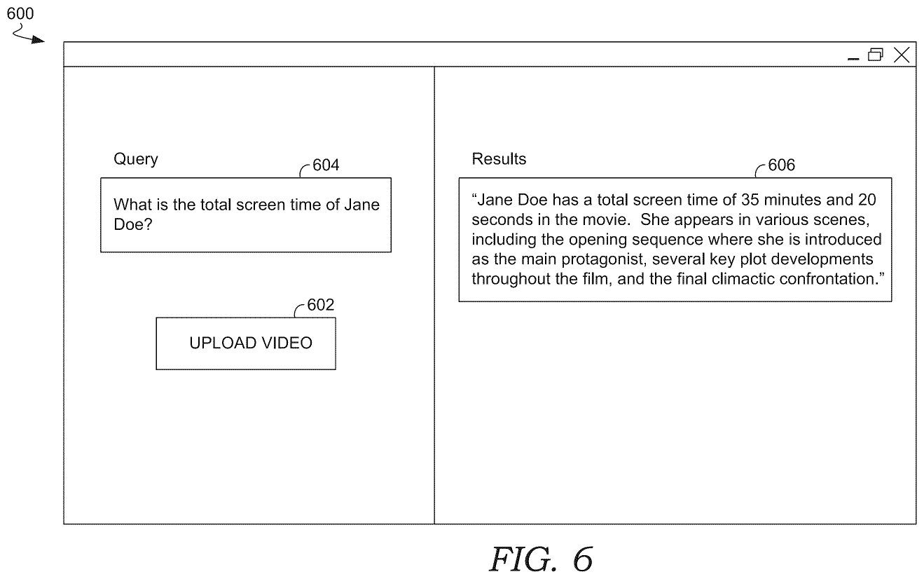

FIG. 6 is a screenshot of an example user interface page 600 illustrating a generated response 606 to a user query 604, according to some embodiments. First, particular embodiments receive an indication that a user has selected the “upload video” button 602. Responsively, particular embodiments upload the multimedia video file. Responsively, the decoding component 204, the audio transcription component 102, and/or the video analysis component 108 performs respective functionality on the multimedia video file. Various embodiments receive an indication that the user has input the query 604. Responsively, the audio-video fusion component 120 performs its functionality to generate the output response 606. For example, a speech-to-text model transcribes all dialogue, and identifies 20 instances where Jane Doe speaks, totaling 12 minutes. A video analytics model detects Jane Doe in 15 scenes, identifying 10 minutes of screen time where she is visible but does not speak. Various embodiments then align the timestamps from the transcript and video metadata, identifying overlapping segments where Jane Doe is both speaking and visible (e.g., to remove overlapping segments). Overlapping segments (where Jane is both seen and heard) are only counted once to avoid duplication. Embodiments then calculate a total screen time of 22 minutes for Jane Doe, accounting for both her spoken dialogue and her silent appearances in the video. Responsively, an LLM generates the output response 606.

Now referring to FIG. 7 and FIG. 8, each block of processes 700 and 800 described herein, comprises a computing process that may be performed using any combination of hardware, firmware, and/or software. For instance, various functions may be carried out by a processor executing instructions stored in memory, dedicated AI hardware accelerator circuitry, or the like. The processes may also be embodied as computer-usable instructions stored on computer storage media. The methods may be provided by a standalone application, a service or hosted service (standalone or in combination with another hosted service), or a plug-in to another product, to name a few. In addition, the processes 700 and/or 800 are described, by way of example, with respect to the system 100 of FIG. 1. However, these processes may additionally or alternatively be executed by any one system, or any combination of systems, including, but not limited to, those described herein.

FIG. 7 is a flow diagram of an example process 700 for generates a response to a user query based on combining at least a portion of a first embedding and at least a portion of a second embedding, according to some embodiments. Per block 702, some embodiments receive a user query associated with a video. For example, referring back to FIG. 4, such query may represent the query 402 (“summarize the last 15 minutes of the movie”). Per block 704, some embodiments access a first embedding representing audio data of the video. An “embedding” as described herein refers to a (e.g., learned or numerical) representation of objects (e.g., words, images, or data points) in a continuous, (e.g., lower-dimensional) vector space. Embeddings in some instances transform high-dimensional data into a lower-dimensional space while preserving the most important relationships. In some embodiments, objects that are similar in some context (e.g., words with similar meanings, images of similar objects) are represented as vectors that are close to each other in this vector space. Embeddings capture important features or patterns in the data, allowing models to process the data more efficiently. Some examples of embeddings include word embeddings (such as Word2Vec, GloVe), where words are mapped to vectors that capture semantic relationships, and image embeddings, where high-dimensional image data is encoded into vectors that represent visual features. In some embodiments, the first (and/or second) embedding is accessed in one or more data stores, such as the vector storage 213 and/or 215 of FIG. 2.

“Audio data” is any data that represents sound, such as files that include speech, music, or other acoustic signals. In some embodiments, audio data is stored in digital format and includes a sequence of binary values that correspond to sampled sound wave amplitudes at specific time intervals. Audio data can be encoded using various formats (e.g., WAV, MP3, AAC) and may include additional metadata such as sampling rate, bit depth, and channels (mono, stereo, etc.). The data can be processed, analyzed, or transmitted for playback, storage, or other purposes in audio applications.

Alternatively or additionally, in some embodiments audio data is indicative of a natural language transcript that is generated based on providing a speech-to-text transformer one or more audio sound segments as input, and wherein the one or more audio sound segments represent the natural language transcript. The transformer model receives raw audio segments as input (e.g., in the form of sound waves). The raw audio is transformed into a time-frequency representation called a spectrogram. In some embodiments, such transformation is done using techniques like the Short-Time Fourier Transform (STFT) or Mel-frequency Cepstral Coefficients (MFCC). A spectrogram visually represents the intensity (amplitude) of different frequency components over time and serves as the model's input. In some embodiments, long audio files are divided into smaller segments to make processing easier, such as splitting by silences or fixed time intervals. The model extracts key acoustic features from the spectrogram. These features capture the patterns in speech, such as pitch, volume, and temporal changes. The aim is to reduce the raw audio data to a manageable set of features that contain enough information for speech recognition.

In some embodiments, the speech-to-text transformer uses an encoder to convert the extracted acoustic features (the spectrogram or feature vector) into a sequence of embeddings. This encoder is adapted to handle sequential data like audio. Each audio segment is encoded into a fixed-length vector (e.g., the first embedding), which captures the essential information in the sound wave. Since transformers do not have an inherent sense of the order of sequences, positional encodings are added to the input embeddings to help the model understand the temporal structure of the audio (e.g., the sequence of sounds or words over time). In some embodiments, the transformer applies a self-attention mechanism across the entire sequence of audio embeddings. This mechanism allows the model to focus on different parts of the input sequence and learn which sounds or acoustic features are most important for predicting the next word or phoneme. For example, it can attend to both the beginning and end of an audio segment to determine the structure of a spoken sentence, much like how transformers process text sequences. The decoder of the transformer takes the sequence of contextualized embeddings produced by the encoder and generates a corresponding sequence of linguistic tokens (words or sub word units). In some embodiments, this is done by learning a mapping between the acoustic features and the text output, essentially learning how certain sounds correspond to letters, words, and phonemes. The decoder generates text sequentially, predicting one word or token (or sub word unit) at a time. The decoder uses both the encoded acoustic features and linguistic knowledge (language modeling) to make these predictions. The transformer uses its learned knowledge of language structure to refine the transcription. For example, it will recognize that certain word sequences are more likely than others (e.g., “How are you?” instead of “How is you?”). The final output is a sequence of words that represents the transcribed audio segment. This sequence is the natural language transcript of the original audio. The transformer can also handle more complex tasks like punctuation and capitalization, producing a well-formatted text output.

Per block 706, some embodiments access a second embedding representing image data of the video. In some embodiments, “image data” refers to the digital representation of an image. For instance, image data can be a set of numerical values that describe the visual content of the image. It can include pixel values, color information, or intensity levels for each point in the image, and/or Bezier Curves, depending on the format (such as grayscale or RGB). In some embodiments, image data is stored in a structured format, such as an array or matrix, where each element corresponds to a pixel in the image.

In some embodiments, image data includes natural language text representing visual metadata, such as, for example, described by the visual metadata 304 of FIG. 3. In some embodiments, the natural language text is generated based on providing a machine learning model one or more portions of a frame of the video as input. For example, as described in FIG. 1, this is represented by what is produced by the image metadata generator 116. In some embodiments, such machine learning model includes a deep learning model trained for object detection, object tracking, and facial recognition, as described, for example with respect to the object recognition module 114 and/or the object tracker 112.

In some embodiments, the image data additionally or alternatively comprises visual metadata of a frame, where the visual metadata includes at least one of, one or more timestamps, a quantity of objects in the frame, a type of object present in the frame, a location of an object in the frame, a direction of movement of the object in the frame, a velocity of the movement, or an activity category for the object. For example, the video is split into individual frames (static images) or sequences of frames (clips). These frames are fed into the pipeline for analysis. Each frame is associated with a timestamp that corresponds to its position in the video (e.g., “00:15:30” for 15 minutes and 30 seconds into the video). In some embodiments, this timestamp is attached to all metadata generated for that specific frame. Some embodiments use object detection algorithms (such as YOLO or Faster R-CNN) to identify and detect objects in the frame. These models can locate multiple objects by identifying their bounding shapees. A bounding shape is a rectangular boundary around the detected object, which helps define the location of the object within the frame. In some embodiments, the number of objects detected in a frame is calculated by counting the bounding shapees.

In some embodiments, object classification algorithms (e.g., using a Convolutional Neural Network (CNN)) identify the type of object present in the frame by classifying the detected objects into predefined categories (e.g., “person,” “car,” “dog”). In some embodiments, the location of each object is determined by the coordinates of the bounding shape (e.g., the top-left and bottom-right corners of the box). For example, if a bounding shape has coordinates (x1, y1) for the top-left and (x2, y2) for the bottom-right, these values indicate the object's location in the frame. Regarding object tracking (Movement and Velocity). Object tracking algorithms, such as SORT (Simple Online and Real-time Tracking) or DeepSORT, may follow objects across multiple frames to analyze their movement. These algorithms link detected objects from frame to frame by comparing their bounding shapees and features like appearance or position, enabling the system to track the same object over time.

In some embodiments, the direction of movement is determined by analyzing how the object's position changes from one frame to the next. For example, if an object's bounding shape moves from (x1, y1) in one frame to (x3, y3) in the next frame, the direction is calculated based on the vector formed by these two points. Velocity of movement is computed in some embodiments by dividing the distance the object has traveled (based on the change in its position) by the time difference between frames. This gives the speed of the object's movement across frames. The direction of movement is the direction in which the object is moving (e.g., “left to right”). The velocity is the calculated speed of the object's movement (e.g., “2 m/s”). Regarding action or activity detection, to classify what the object is doing, particular embodiments use activity recognition models (such as I3D or SlowFast). These models analyze sequences of frames to understand the temporal dynamics (changes in object posture, interactions with other objects, etc.) and categorize activities. Various embodiments process multiple frames to detect actions like “walking,” “running,” “sitting,” or “interacting with objects.” These models extract features that represent both spatial (appearance of the object) and temporal (changes over time) aspects of the object, which are then mapped to predefined activity categories.

Per block 708, some embodiments provide a representation of the first embedding, a representation of a second embedding, and a representation of the user query as input into a model, wherein the model generates a response to the user query based at least in part on combining (and/or selecting from) at least a portion of the representation of the first embedding with at least a portion of the representation of the second embedding. A “representation” as described herein refers to the embedding or user query itself or some other value that represents the embedding or user query. For example, a “representation” of an embedding may be an audio transcript itself in natural language form or a vector that represents such audio transcript. For instance, when the representation is the natural language form of an embedding, the embedding, for example, may first be decoded back to natural language form so that a language model can process it as a text prompt. In another example, the representation of the user query may be the query itself in natural language text, or a text embedding, which may be a numerical embedding representing the query.

In an example illustration of the “combining” at block 708, a generator first aligns the audio embedding and video embedding using timestamps. For instance, the words spoken at time “00:10:05” in the transcript are aligned with the corresponding video frame metadata for that same timestamp. The generator may use an attention mechanism (similar to how transformers handle multimodal data) to focus on relevant parts of the audio and video embeddings. This ensures that the key elements from both modalities are given proper weight in the generated response. In some embodiments, the generator applies cross-attention between the audio and video embeddings, allowing the model to learn which aspects of the video context are most relevant to the audio content and vice versa. This enables the model to integrate the visual context when generating a response related to spoken dialogue.

In some embodiments, the audio and video embeddings are combined by either concatenating or summing them. With respect to concatenation, the two embeddings are concatenated into a single, larger vector, allowing the model to preserve the information from both modalities independently. In some embodiments, the embeddings are summed element-wise to create a unified representation. This approach assumes the embeddings have the same dimensionality and merges the two modalities more closely. Transformer models can directly combine embeddings from multiple modalities by learning correlations between audio and visual features. The generator uses these learned representations to create a shared understanding of the audio and visual data. After the embeddings are combined, the generator processes the resulting vector to generate a coherent natural language response. It uses a neural language model (e.g., GPT) to interpret the combined embedding and produce a response that reflects both the visual and auditory aspects of the data. In some embodiments, the LLM part of the generator will take the combined embeddings and use its language understanding to generate text. For example, it may generate a sentence like: “At 00:10:05, the coach said, ‘Focus on defense,’ while pointing towards the defensive line.” The generator produces a natural language response that captures the essence of both the spoken audio (what was said) and the visual context (what was happening in the video). The output may provide a holistic summary or answer to the user's query, combining both modalities.

Some embodiments generate a natural language transcript from the audio data, where the natural language transcript is associated with corresponding timestamps. And based at least in part on analyzing a frame of the video data, some embodiments generate visual metadata associated with the video data, where the generating of the response is based at least in part on aligning the frame with a respective timestamp of the corresponding timestamps and combining at least a portion of the natural language transcript with natural language text representing at least a portion of the visual metadata. For example, in some embodiments this involves merging the textual content from both sources (audio and video data) to create a more complete description of the scene. For example, a transcript reads, “The coach says, ‘Focus on defense.’” Visual metadata indicates that “The coach is standing near the sideline, pointing toward the defensive end.” The combined generated output is “The coach says, ‘Focus on defense,’ while standing near the sideline and pointing toward the defensive end.” In some embodiments, each frame in the video is associated with a timestamp. This timestamp is used to align the video frame with corresponding elements from the natural language transcript (derived from speech-to-text processing) and visual metadata (generated from video analysis). Various embodiments align the video frames with the transcript using the timestamps.

In some embodiments, the model indicated at block 708 represents a Retrieval Augmented Generation (RAG) model, where the generating of the response to the user query is further based on retrieving information associated with the first embedding (e.g., retrieving the first embedding itself, corresponding metadata, and/or the raw audio/video data itself) and the second embedding in a data store based on the user query and passing the information to a generative component of the RAG to generate a natural language response. In some embodiments, this functionality represents or includes the functionality as described with respect to the retriever module 122 of FIG. 1 and the generator module 124 of FIG. 1.

In some embodiments, the response to the user query includes at least one of: a text summary based on the user query specifying a particular time interval (e.g., as described with respect to FIG. 4), a quantity of screen time for one or more speakers in the video (e.g., as described with respect to FIG. 6), generated text without one or more words (e.g., bad language) included in the audio data or the video data (e.g., as described with respect to FIG. 5), or generated text that combines both the audio data and the video data, such as a summary of both the audio and video data.

FIG. 8 is a flow diagram of an example process 800 for generating a natural language response, according to some embodiments. In some embodiments, the process 800 includes one or more of the blocks in the process 700 and associated functionality as described with respect to FIG. 7. Per block 803, some embodiments decode audio data into an audio stream and video data into a video stream. In some embodiments, block 803 represents or includes the functionality as described with respect to the decoder 204 of FIG. 2.

Per block 805, some embodiments generate a natural language transcript from the audio stream, wherein the natural language transcript is associated with corresponding timestamps. In some embodiments, block 805 represents or includes the functionality as described with respect to 208 of FIG. 2 and/or the speech-to-text module 104 of FIG. 4. Per block 807, based at least in part on analyzing a frame of the video stream, some embodiments generate visual metadata associated with the video data. In some embodiments, block 807 represents or includes the functionality as described with respect to the video LLM (or VLM) inference/analytics 206 and/or image metadata generator 116 of FIG. 1. For example, in some embodiments, the visual metadata includes natural language text (e.g., 304 of FIG. 3) that is generated based on providing a machine learning model (e.g., a CLIP model or a deep learning model trained for object detection, object tracking, and/or facial recognition) a representation of one or more portions of the frame as input

Per block 809, some embodiments generate a natural language response based on aligning the frame with a respective timestamp of the corresponding timestamps. For example, the frame at 00:10:05 in the video is aligned with the transcript at 00:10:05, where the transcript might state: “The coach says, ‘Focus on defense.” In some embodiments, each frame is processed by a video model (such as a CNN or a transformer for visual data) to generate a video embedding. This embedding captures the visual information in the frame (e.g., objects, actions, movements). In some embodiments, the audio transcript is processed by a natural language model to generate an audio embedding. This embedding encodes the semantic meaning of the spoken content. After aligning the video frame and transcript based on their timestamps, some embodiments combine the video embedding and the audio embedding to form a unified representation. This can be done through techniques like concatenation, summation, or using attention mechanisms. The generator integrates the content of the visual scene (actions, objects) with the meaning of the spoken words to provide context to both. With the unified representation, the generator uses its language modeling capabilities to produce a natural language response that reflects both the visual and audio data. The model understands the relationship between what is being shown in the video and what is being said, and it combines them to produce a coherent output. For instance, the generator might understand that the video shows the coach pointing toward the defensive players while the audio transcript says, “Focus on defense.”

Continuing with block 809, some embodiments alternatively or additionally combine (as described above) or select from a representation of at least a portion of the natural language transcript and at least a portion of the visual metadata. With respect to the “select” pathway, for example, the first step in some instances is to interpret the user query and determine whether the user is specifically asking for information that relies more on the audio (spoken content) or the video (visual content). For example, an audio-focused query might be” “What did the coach say at halftime?”—This indicates that the spoken content (audio) is the most relevant. A video-focused query might be: “What was the player doing during the game?”—This focuses on the actions or movements of players, making the visual content (video) more relevant.

Once the query is understood, some embodiments decide whether to use the audio transcript or the video metadata for generating the response. This can be done in any suitable manner. For example, some embodiments use simple heuristic rules to decide based on keywords or the structure of the query. For example, if the query includes words like “say,” “talk,” “discuss,” or “speak,” the model might prioritize the audio transcript. If the query includes words like “do,” “action,” “move,” “position,” or “gesture,” the model might prioritize the video data. In some embodiments, the model employs an attention mechanism that learns which modality (audio or video) is more relevant to the query. The model can assign higher attention to the data that matches the user's intent. For instance, when the query is analyzed, the model may dynamically adjust its focus on audio embeddings if the context implies a question about speech or dialogue, and shift focus to video embeddings when it involves actions or visuals.

Some embodiments employ specialized preprocessing steps for handling queries that are audio-focused or video-focused. For instance, for audio queries, the system can extract and process the audio transcript, disregarding the visual metadata. For video queries, the system can focus only on analyzing and retrieving relevant frames and metadata about objects, movements, and actions. In some instances, if the query is primarily about what was said, the retrieval model prioritizes searching the transcript data and ignores or deprioritizes the visual metadata. For instance, in the query “What were the coach's instructions?” the system retrieves the relevant part of the transcript (e.g., “The coach says, ‘Focus on defense.’”) and generates the response based on that text, without referring to video metadata. Once the relevant data (either audio or video) is selected, the generator processes only the chosen data to produce the natural language response. In some embodiments, the generator processes the audio transcript embeddings and uses an LLM (Large Language Model) to generate a response based purely on what was said.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 930 (e.g., LLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/VLM/MMLM/etc. with external knowledge, so that answers to specific questions or queries or requests are more relevant—such as in a case where specific knowledge is required. The RAG component 992 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features—such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use—or capable of accessing or using—plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated—e.g., recursively—for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources—such as the plug-ins/APIs 995.

FIG. 9B is a block diagram of an example implementation in which the generative LM 930 includes a transformer encoder-decoder. For example, assume input text such as “Who discovered gravity” is tokenized (e.g., by the tokenizer 910 of FIG. 9A) into tokens such as words, and each token is encoded (e.g., by the embedding component 920 of FIG. 99A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may use distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

In an example embodiment, one or more processors comprise processing circuitry to receive a user query associated with a video; access a first embedding representing audio data of the video; access a second embedding representing image data of the video; and generate, based at least on a model processing a user query and a combination of a representation of the first embedding and a representation of the second embedding, a response to the user query.

In some embodiments, the processing circuitry is further to: generate a natural language transcript from the audio data, wherein the natural language transcript is associated with corresponding timestamps; and based at least on analyzing a frame of the image data, generate visual metadata associated with the image data, wherein the generating of the response is based at least on aligning the frame with a respective timestamp of the corresponding timestamps and combining at least a portion of the natural language transcript with natural language text representing at least a portion of the visual metadata.

In some embodiments, the model represents a Retrieval Augmented Generation (RAG) model, and wherein the generating of the response to the user query is further based at least on retrieving information associated with the first embedding and the second embedding in a data store based at least on the user query and passing the information to a generative component of the RAG to generate a natural language response.

In some embodiments, the audio data is indicative of a natural language transcript that is generated based at least on providing a speech-to-text transformer one or more audio sound segments as input, and wherein the one or more audio sound segments represent the natural language transcript.

In some embodiments, the image data includes natural language text representing visual metadata, and wherein the natural language text is generated based at least on providing a machine learning model one or more portions of a frame of the video as input.

In some embodiments, the machine learning model includes a deep learning model trained for at least one of object detection, object tracking, or facial recognition.

In some embodiments, the image data comprises visual metadata of a frame, and wherein the visual metadata includes at least one of: one or more timestamps, a quantity of objects in the frame, a type of object present in the frame, a location of an object in the frame, a direction of movement of the object in the frame, a velocity of the movement, or an activity category for the object.

In some embodiments, the response to the user query includes at least one of: a text summary based at least on the user query specifying a particular time interval, a quantity of screen time for one or more speakers in the video, generated text without one or more words included in the audio data or the image data, or generated text that combines both the audio data and the video data.

In some embodiments, the one or more processors is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system implementing one or more large language models (LLMs); a system implementing one or more vision language models (VLMs); a system implementing one or more multi-modal language models (MMLMs); a system incorporating one or more virtual machines (VMs); a system implemented at least partially in a data center; or a system implemented at least partially using cloud computing resources.

In one embodiments, a system comprises one or more processors to: decode audio data into an audio stream and video data into a video stream; generate a natural language transcript from the audio stream, the natural language transcript associated with corresponding timestamps; based at least on analyzing a frame of the video stream, generate visual metadata associated with the video stream; and generate a natural language response based at least on at least one of: aligning the frame with a respective timestamp of the corresponding timestamps; or combining or selecting from a representation of at least a portion of the natural language transcript and a representation of at least a portion of the visual metadata.

In some embodiments, the generation of the natural language response is based at least on retrieving, via a Retrieval Augmented Generation (RAG) model, information associated with at least one of the audio data and the video data in a data store in response to a user query and passing the information to a generative component of the RAG to generate the natural language response.

In some embodiments, the natural language transcript is generated based at least on providing a speech-to-text transformer one or more audio sound segments as input, and wherein the one or more audio sound segments represent the natural language transcript.

In some embodiments, the visual metadata includes natural language text that is generated based at least on providing a machine learning model a representation of one or more portions of the frame as input.

In some embodiments, the machine learning model includes a deep learning model trained for object detection, object tracking, and facial recognition.

In some embodiments, the visual metadata includes at least one of, one or more timestamps, a quantity of objects in the frame, a type of object present in the frame, a location of an object in the frame, a direction of movement of the object in the frame, a velocity of the movement, or an activity category for the object.

In some embodiments, the natural language response includes at least one of: a text summary based at least on a user query specifying a particular time interval, a quantity of screen time for one or more speakers in a video, generated text without one or more words included in the audio data or the video data, or generated text that combines both the audio data and the video data.

In some embodiments, the system includes at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system implementing one or more large language models (LLMs); a system implementing one or more vision language models (VLMs); a system implementing one or more multi-modal language models (MMLMs); a system incorporating one or more virtual machines (VMs); a system implemented at least partially in a data center; or a system implemented at least partially using cloud computing resources.

In one embodiments, a method comprises: receiving, using a computing device, audio data of a video and image data of the video; receiving, using the computing device, a user query; sending, using one or more application programming interfaces (APIs) of a container executed using the computing device, and to one or more models hosted using a remote computing device, data representative of the user query and at least one of the audio data or the image data; receiving, using the one or more APIs and from the remote computing device responsive to the sending of the data, a natural language response to the user query, the natural language response generated using the one or more models; and causing presentation, at least one of visually or audibly, of the natural language response using the computing device.

In some embodiments, the method further comprises: generating a natural language transcript from the audio data, wherein the natural language transcript is associated with corresponding timestamps; and based at least on analyzing a frame of the video data, generate visual metadata associated with the video stream, wherein the generating of the response is based at least on aligning the frame with a respective timestamp of the corresponding timestamps and combining at least a portion of the natural language transcript with natural language text representing at least a portion of the visual metadata.

In some embodiments, the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system implementing one or more large language models (LLMs); a system implementing one or more vision language models (VLMs); a system implementing one or more multi-modal language models (MMLMs); a system incorporating one or more virtual machines (VMs); a system implemented at least partially in a data center; or a system implemented at least partially using cloud computing resources.

What is claimed is:

1. One or more processors comprising processing circuitry to:
receive a user query associated with a video;
access a first embedding representing audio data of the video;
access a second embedding representing image data of the video; and
generate, based at least on a model processing a user query and a combination of a representation of the first embedding and a representation of the second embedding, a response to the user query.

2. The one or more processors of claim 1, wherein the processing circuitry is further to:
generate a natural language transcript from the audio data, wherein the natural language transcript is associated with corresponding timestamps; and
based at least on analyzing a frame of the image data, generate visual metadata associated with the image data, wherein the generating of the response is based at least on aligning the frame with a respective timestamp of the corresponding timestamps and combining at least a portion of the natural language transcript with natural language text representing at least a portion of the visual metadata.

3. The one or more processors of claim 1, wherein the model represents a Retrieval Augmented Generation (RAG) model, and wherein the generating of the response to the user query is further based at least on retrieving information associated with the first embedding and the second embedding in a data store based at least on the user query and passing the information to a generative component of the RAG to generate a natural language response.

4. The one or more processors of claim 1, wherein the audio data is indicative of a natural language transcript that is generated based at least on providing a speech-to-text transformer one or more audio sound segments as input, and wherein the one or more audio sound segments represent the natural language transcript.

5. The one or more processors of claim 1, wherein the image data includes natural language text representing visual metadata, and wherein the natural language text is generated based at least on providing a machine learning model one or more portions of a frame of the video as input.

6. The one or more processors of claim 5, wherein the machine learning model includes a deep learning model trained for at least one of object detection, object tracking, or facial recognition.

7. The one or more processors of claim 1, wherein the image data comprises visual metadata of a frame, and wherein the visual metadata includes at least one of: one or more timestamps, a quantity of objects in the frame, a type of object present in the frame, a location of an object in the frame, a direction of movement of the object in the frame, a velocity of the movement, or an activity category for the object.

8. The one or more processors of claim 1, wherein the response to the user query includes at least one of: a text summary based at least on the user query specifying a particular time interval, a quantity of screen time for one or more speakers in the video, generated text without one or more words included in the audio data or the image data, or generated text that combines both the audio data and the video data.

9. The one or more processors of claim 1, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system implementing one or more large language models (LLMs);
a system implementing one or more vision language models (VLMs);
a system implementing one or more multi-modal language models (MMLMs);
a system incorporating one or more virtual machines (VMs);
a system implemented at least partially in a data center; or
a system implemented at least partially using cloud computing resources.

10. A system comprising one or more processors to:
decode audio data into an audio stream and video data into a video stream;
generate a natural language transcript from the audio stream, the natural language transcript associated with corresponding timestamps;
based at least on analyzing a frame of the video stream, generate visual metadata associated with the video stream; and
generate a natural language response based at least on at least one of:
aligning the frame with a respective timestamp of the corresponding timestamps; or
combining or selecting from a representation of at least a portion of the natural language transcript and a representation of at least a portion of the visual metadata.

11. The system of claim 10, wherein the generation of the natural language response is based at least on retrieving, via a Retrieval Augmented Generation (RAG) model, information associated with at least one of the audio data and the video data in a data store in response to a user query and passing the information to a generative component of the RAG to generate the natural language response.

12. The system of claim 10, wherein the natural language transcript is generated based at least on providing a speech-to-text transformer one or more audio sound segments as input, and wherein the one or more audio sound segments represent the natural language transcript.

13. The system of claim 10, wherein the visual metadata includes natural language text that is generated based at least on providing a machine learning model a representation of one or more portions of the frame as input.

14. The system of claim 13, wherein the machine learning model includes a deep learning model trained for object detection, object tracking, and facial recognition.

15. The system of claim 10, wherein the visual metadata includes at least one of, one or more timestamps, a quantity of objects in the frame, a type of object present in the frame, a location of an object in the frame, a direction of movement of the object in the frame, a velocity of the movement, or an activity category for the object.

16. The system of claim 10, wherein the natural language response includes at least one of: a text summary based at least on a user query specifying a particular time interval, a quantity of screen time for one or more speakers in a video, generated text without one or more words included in the audio data or the video data, or generated text that combines both the audio data and the video data.

17. The system of claim 10, wherein the system includes at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system implementing one or more large language models (LLMs);
a system implementing one or more vision language models (VLMs);
a system implementing one or more multi-modal language models (MMLMs);
a system incorporating one or more virtual machines (VMs);
a system implemented at least partially in a data center; or
a system implemented at least partially using cloud computing resources.

18. A method comprising:
receiving, using a computing device, audio data of a video and image data of the video;
receiving, using the computing device, a user query;
sending, using one or more application programming interfaces (APIs) of a container executed using the computing device, and to one or more models hosted using a remote computing device, data representative of the user query and at least one of the audio data or the image data; and
receiving, using the one or more APIs and from the remote computing device responsive to the sending of the data, a natural language response to the user query, the natural language response generated using the one or more models; and
causing presentation, at least one of visually or audibly, of the natural language response using the computing device.

19. The method of claim 18, further comprising:
generating a natural language transcript from the audio data, wherein the natural language transcript is associated with corresponding timestamps; and
based at least on analyzing a frame of the video data, generate visual metadata associated with the video stream, wherein the generating of the response is based at least on aligning the frame with a respective timestamp of the corresponding timestamps and combining at least a portion of the natural language transcript with natural language text representing at least a portion of the visual metadata.

20. The method of claim 18, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system implementing one or more large language models (LLMs);
a system implementing one or more vision language models (VLMs);
a system implementing one or more multi-modal language models (MMLMs);
a system incorporating one or more virtual machines (VMs);
a system implemented at least partially in a data center; or
a system implemented at least partially using cloud computing resources.
